(19) United States
(12) Patent Application Publication
(10) Pub. No.: US 2026/0129479 A1
(43) Pub. Date: May 7, 2026

(54) METHODS AND SYSTEMS FOR OPTIMIZING COMMUNICATION RELIABILITY IN A WIRELESS NETWORK

(71) Applicant: Samsung Electronics Co., Ltd., Suwon-si (KR)

(72) Inventors: Karthikeyan SUBRAMANIAM, Bangalore (IN); Senthilkumar SUBRAMANIAN, Bangalore (IN); Sudhakar BALUSAMY, Bangalore (IN); Akash DAYALAN, Bangalore (IN); Nivedya Parambath SASI, Bangalore (IN); Varini GUPTA, Bangalore (IN)

(21) Appl. No.: 19/382,902

(22) Filed: Nov. 7, 2025

Related U.S. Application Data
(63) Continuation of application No. PCT/KR2025/018036, filed on Nov. 5, 2025.

(30) Foreign Application Priority Data
Nov. 5, 2024 (IN) 202441084755
Oct. 23, 2025 (IN) 2024 41084755

(51) Int. Cl. H04W 24/02; H04L 41/14; H04W 48/18

(52) U.S. Cl. CPC H04W 24/02; H04L 41/14; H04W 48/18

(57) ABSTRACT

Methods for optimizing communication reliability in a wireless network are provided. The method includes receiving a communication performance message from a network consumer entity. The method selects network producer entity for network consumer entity based on a local reliability table and global reliability table, wherein local reliability table comprises network producer entity for requested network consumer entity with a highest global reliability score and global reliability table includes network producer entity based on aggregated local reliability scores of all consumers. The method determines based on highest local reliability score among local reliability score of network producers available for requested network consumer entity in local reliability table and global reliability score of network producer entities not available for requested consumer entity in local reliability table. The method further updates final selection of network producer entity with network consumer entity, based on combination of global reliability table and local reliability table.

### CROSS REFERENCE TO RELATED APPLICATION(S)

This application is a continuation application, claiming priority under 35 U.S.C. § 365(c), of an International application No. PCT/KR2025/018036, filed on Nov. 5, 2025, which is based on and claims the benefit of an Indian Provisional patent application number 202441084755, filed on Nov. 5, 2024, in the Indian Intellectual Property Office, and of an Indian Complete patent application number 202441084755, filed on Oct. 23, 2025, in the Indian Intellectual Property Office, the disclosure of each of which is incorporated by reference herein in its entirety.

### TECHNICAL FIELD

The disclosure relates to a wireless communication network. More particularly, the disclosure relates to methods and a network repository entity for optimizing communication reliability between a network producer entity and a network consumer entity using the network repository entity.

### BACKGROUND

Currently, fifth-generation (5G) Ultra-Reliable Low-Latency Communication (URLLC) requires stringent end-to-end latency guarantees, ranging from 1 to 5 milliseconds as defined by the Third Generation Partnership Project (3GPP), to support mission-critical applications such as autonomous driving, industrial automation, remote surgery, and smart grid control. Achieving such low latency necessitates optimization across all segments of a wireless network (or wireless communication network), including a 5G Core (5GC). In modern 5GC deployments, a network producer entity and a network consumer entity (e.g., Access and Mobility Management Function (AMF) and Session Management Function (SMF)) may be instantiated within a data center or distributed across different data centers in a public cloud environment. Such distributed deployments introduce complex network paths between the network consumer entity and the network producer entity. The network consumer entity relies on a network repository entity to discover network producer entity using Network Function (NF) profiles, which indicate the availability and health status of network producer instances. However, the network profile may report the network producer instance as healthy even though the network consumer entity experiences network connectivity issues such as high latency, increased packet loss, or complete communication failure with that instance. The discrepancy can severely impact URLLC control signal establishment, leading to a failure in meeting stringent end-to-end latency Key Performance Indicators (KPIs). Hence, there is need of a mechanism whereby the network consumer entity detects such network-level issues in real time and proactively notifies the network repository entity to update the status of the affected network producer instance. Thus, enabling the subsequent network consumer instances to select alternative network producer instances, improving the packet delay budget by 47% for URLLC and 39% for Enhanced Mobile Broadband (eMBB) in the distributed 5GC (for example).

FIG. 1A is an example graph illustrating the relevant key performance indicators (KPIs) of the uRLLC and the eMBB, comprising end-to-end Packet Delay Budget (PDB) and Packet Error Rate (PER) according to the related art.

Referring to FIG. 1A, it illustrates the comparison between the current network producer discovery and a smart network producer discovery, with the differences in the PDB and the PER for 5G communication network. Therefore, currently no existing method is related to smart reliable network producer discovery and the reduction of C-P establishment time.

Further, in the fifth generation (5G) core architecture, the network repository entity relies on heartbeat or status notifications from the network producer entity to assess the health of the network producer. Therefore, the limitations such in the delayed failure detection, if the network producer entity fails immediately after the last heartbeat, the network repository entity continues to advertise until the timeout period expires, so as to lead to failed communications from the network consumer entity. In other limitation, such as in the network path ignorance, the network may failure in a transport path about packet loss (for example) between the network consumer entity and the network producer entity go unnoticed, as the network repository entity has no visibility into transport-level failures.

FIG. 1B is an example diagram illustrating the existing reliability gap in the 5G core according to the related art.

Referring to FIG. 1B, the reliability in the 5G Service-Based Architecture (SBA) is a critical factor in ensuring compliance with Service Level Agreements (SLAs) and meeting Quality Flow Indicator (QFI) requirements across service categories such as enhanced Mobile Broadband (eMBB), Ultra-Reliable Low Latency Communication (URLLC), and massive Machine Type Communication (mMTC). In the current design, Network Function (NF) producers periodically notify the Network Repository Function (NRF) about their state, and the NF consumers rely on the NRF to obtain producer addresses. This unidirectional reporting introduces two major reliability gaps. First, if the NF producer fails between notification intervals, the NRF may still direct consumers to that producer, resulting in failed requests. Second, the transport path degradations between the consumer and the producer remain invisible to the NRF, even when the producer itself is healthy, leading to undetected communication failures. Hence, there is no existing prior art related to the NF consumer feedback based smart reliable NF producer discovery in the NRF.

FIG. 2 is an example diagram illustrating the existing network producer entity discovery in the 5G core, wherein the network consumer entity facing a Http session failure, according to the related art.

Referring to FIG. 2, the network consumer entity initiates the network discovery by sending a request to the network repository entity, which responds by providing the profiles of available network producers such as a first producer and a second producer. The network consumer entity attempts to select the second producer for the communication with the network consumer. However, the second producer has already gone into a down state immediately after the last heartbeat update to the network repository entity. Since the network repository entity updates the producer status after the heartbeat timeout, continues to advertise that the second producer is available, leading the network consumer entity to attempt the connection. Thus, the network consumer entity attempts to communicate with the network producer entity fails, and the consumer receives the connection failure response. Meanwhile, the network repository entity eventually detects the missed heartbeat, updates the second producer state to “down,” and stops advertising for future discovery. Therefore, FIG. 2 discloses delayed failure detection, where the gap between the actual producer failure and the network repository entity causes service degradation and the failed communications.

FIG. 3 is an example diagram illustrating the existing network producer entity discovery in the 5G core, wherein the network consumer entity facing the Http packet loss in a transport network, according to the related art.

Referring to FIG. 3, the network consumer entity initiates the discovery of the network by sending the request to the network repository entity, which responds with the profiles of available network producer entity, such as first producer and the second producer. Based on the received information, the network consumer entity attempts to select the second producer for the communication. During the service establishment, the network consumer entity encounters packet loss in the HTTP/2 over Transmission Control Protocol (TCP) connection between itself and the second producer.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and systems for optimizing communication reliability in a wireless communication network.

Another aspect of the disclosure is to receive a communication performance message form a network consumer entity, where the communication performance message is related to a network producer entity.

Another aspect of the disclosure is to determine a reliability score for the network producer entity based on at least one of the received communication performance message and historical communication data. the reliability score includes a local reliability score indicating a reliability between the network consumer entity and the network producer entity and a global reliability score indicating reliability of the network producer entity across a plurality of network consumer entities including the network consumer entity.

Another aspect of the disclosure is to select the network producer entity for the network consumer entity based on a global reliability table, wherein the global reliability table comprises the network producer entity with a highest reliability score. the global reliability table comprises a plurality of global reliability scores of the plurality of network producer entities.

Another aspect of the disclosure is to determine based on the highest score among local reliability score of the network producers available for requested network consumer entity in the local reliability table and global reliability score of network producer entities not available for requested consumer entity in the local reliability table. Another aspect of the disclosure is to determine whether the selected network producer entity is compatible with the network consumer entity based on the local reliability table, wherein the local reliability table comprises a plurality of local reliability scores between each of the plurality of network producer entities and the network consumer entity.

Another aspect of the disclosure is to update a final selection of the network producer entity with the network consumer entity, for communicating with the network consumer entity, based on a combination of the global reliability table and the local reliability table. Another aspect of the disclosure is based on determining that the selected network producer entity is compatible with the network consumer entity, to update, the selection of the network producer entity with the network consumer entity, for communicating with the network consumer entity, based on a combination of the global reliability table and the local reliability table.

Another aspect of the disclosure is to receive the reliability score from a Network Data Analytics Function (NWDAF), for the network producer entity.

Another aspect of the disclosure is to determine the reliability score for the network producer entity based on at least one of the received communication performance message and historical communication data.

Additional aspects will be set forth in part in the description which follows and, in part, will be apparent from the description, or may be learned by practice of the presented embodiments.

In accordance with an aspect of the disclosure, a method performed by a network repository entity for optimizing communication reliability in a wireless network is provided. The method includes receiving, by the network repository entity, a communication performance message from a network consumer entity, wherein the communication performance message is related to a network producer entity, determining, by the network repository entity, a reliability score for the network producer entity, the reliability score including a local reliability score indicating a reliability between the network consumer entity and the network producer entity and a global reliability score indicating reliability of the network producer entity based on aggregated local reliability scores across a plurality of network consumer entities including the network consumer entity selecting, by the network repository entity, a network producer entity having a highest global reliability score among a plurality of network producer entities based on a global reliability table, wherein the global reliability table comprises a plurality of global reliability scores of the plurality of network producer entities, determining, by the network repository entity, whether the selected network producer entity is compatible with the network consumer entity based on the local reliability table, wherein the local reliability table comprises a plurality of local reliability scores between each of the plurality of network producer entities and the network consumer entity. The method further includes updating, by the network repository entity, a final selection of the network producer entity with the network consumer entity, for communicating with the network consumer entity, based on a combination of the global reliability table and the local reliability table.

In accordance with another aspect of the disclosure, a network repository entity is provided. The network repository entity includes memory, including one or more storage media, storing instructions, a network repository controller, one or more processors communicatively coupled with the network repository controller and the memory, wherein the instructions, when executed by the one or more processors individually or collectively, cause the network repository entity to receive a communication performance message from a network consumer entity, wherein the communication performance message is related to a network producer entity, determine a reliability score for the network producer entity, the reliability score including a local reliability score indicating a reliability between the network consumer entity and the network producer entity and a global reliability score indicating reliability of the network producer entity based on aggregated local reliability scores across a plurality of network consumer entities including the network consumer entity select the network producer entity for the network consumer entity having a highest global reliability score among a plurality of network producer entities based on a global reliability table, wherein the global reliability table comprises a plurality of global reliability scores of the plurality of network producer entities determine whether the selected network producer entity is compatible with the network consumer entity based on the local reliability table, wherein the local reliability table comprises a plurality of local reliability scores between each of the plurality of network producer entities and the network consumer entity. The network repository entity is configured to update a final selection of the network producer entity with the network consumer entity, for communicating with the network consumer entity, based on a combination of the global reliability table and the local reliability table.

In accordance with another aspect of the disclosure, one or more non-transitory computer-readable storage media storing one or more computer programs including computer-executable instructions that, when executed by one or more processors of a network repository entity individually or collectively, cause the network repository entity to perform operations are provided. The operations include receiving, by the network repository entity, a communication performance message from a network consumer entity, wherein the communication performance message is related to a network producer entity, determining, by the network repository entity, a reliability score for the network producer entity, the reliability score including a local reliability score indicating a reliability between the network consumer entity and the network producer entity and a global reliability score indicating reliability of the network producer entity across a plurality of network consumer entities including the network consumer entity, selecting, by the network repository entity, the reliability score including a local reliability score indicating a reliability between the network consumer entity and the network producer entity and a global reliability score indicating reliability of the network producer entity based on aggregated local reliability scores across a plurality of network consumer entities including the network consumer entity, determining, by the network repository entity, whether the selected network producer entity is compatible with the network consumer entity based on the local reliability table, wherein the local reliability table comprises a plurality of local reliability scores between each of the plurality of network producer entities and the network consumer entity. The instructions further includes updating, by the network repository entity, a final selection of the network producer entity with the network consumer entity, for communicating with the network consumer entity, based on a combination of the global reliability table and the local reliability table.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1A is an example graph illustrating the relevant key performance indicators (KPIs) of uRLLC and eMBB, comprising end-to-end Packet Delay Budget (PDB) and Packet Error Rate (PER), according to the related art;

FIG. 1B is an example diagram illustrating the existing reliability gap in the 5G core, according to the related art;

FIG. 2 is an example diagram illustrating the existing network producer entity discovery in the 5G core, wherein the network consumer entity facing the Http session failure, according to the related art;

FIG. 3 is an example diagram illustrating the existing network producer entity discovery in the 5G core, wherein the network consumer entity facing the Http packet loss in a transport network, according to the related art;

FIG. 4 is an example architecture diagram illustrating a service aware network producer discovery in the 5GC, according to an embodiment of the disclosure;

FIGS. 5A and 5B are example architecture diagrams illustrating the service aware network producer discovery architecture using a Network Data Analytics Function (NWDAF) in the 5GC, according to various embodiments of the disclosure;

FIG. 6 is an example diagram illustrating the service aware network producer discovery in the 5GC, wherein the producer outage with down, heartbeat timeout, with URLLC focus, according to an embodiment of the disclosure;

FIG. 7 is an example diagram illustrating the service aware network producer discovery in the 5GC, wherein the consumer-producer specific transport degradation with eMBB focus, according to an embodiment of the disclosure;

FIG. 8 is an example diagram illustrating a reliability computation using an Artificial Intelligence (AI) module in an Ultra reliable low latency communication (URLLC), according to an embodiment of the disclosure;

FIG. 9 is an example diagram illustrating the reliability computation using the AI module for performing network discovery to avail services, according to an embodiment of the disclosure;

FIG. 10 is an example diagram illustrating the reliability computation using the AI module for calculating the URLLC communication producer outage, according to an embodiment of the disclosure;

FIG. 11 is an example diagram illustrating the reliability computation using the AI module for requesting subsequent network discovery to avail the service, according to an embodiment of the disclosure;

FIGS. 12 and 13 are example diagrams illustrating the reliability computation using the AI module by performing eMBB communication during packet loss, according to various embodiment of the disclosure;

FIG. 14 is an example diagram illustrating the reliability computation using the AI module for subsequent network discovery requests for the first service, according to an embodiment of the disclosure;

FIG. 15 is an example diagram illustrating the network repository entity collecting the network producer service down notification from the network consumer entity and update reliability score table, according to embodiment of the disclosure;

FIG. 16 is an example sequence diagram illustrating the network repository entity collecting the network producer service down notification from the network consumer entity and update reliability score table, according to an embodiment of the disclosure;

FIGS. 17 and 18 are example diagrams illustrating the network repository entity collecting the network producer service down notification from the network consumer and update reliability score table, according to various embodiments of the disclosure;

FIG. 19 is an example diagram illustrating the network repository entity collecting the network producer service down notification from the network consumer and update reliability score table, according to an embodiment of the disclosure;

FIGS. 20, 21, 22, 23, and 24 are example diagrams illustrating the network repository entity collecting the network producer entity packet loss notification from the network consumer and update reliability score table, according to various embodiments of the disclosure;

FIG. 25 is an example diagram illustrating hardware components of the network repository entity, for optimizing communication reliability in the wireless communication network, according to an embodiment of the disclosure;

FIG. 26 is an example diagram illustrating hardware components of the network producer entity, for optimizing communication reliability in the wireless communication network, according to an embodiment as of the disclosure;

FIG. 27 is an example diagram illustrating hardware components of the network consumer entity, for optimizing communication reliability in the wireless communication network, according to an embodiment of the disclosure; and

FIG. 28 is an example flow diagram depicting a method for optimizing communication reliability in the wireless communication network by the network repository entity, according to an embodiment of the disclosure.

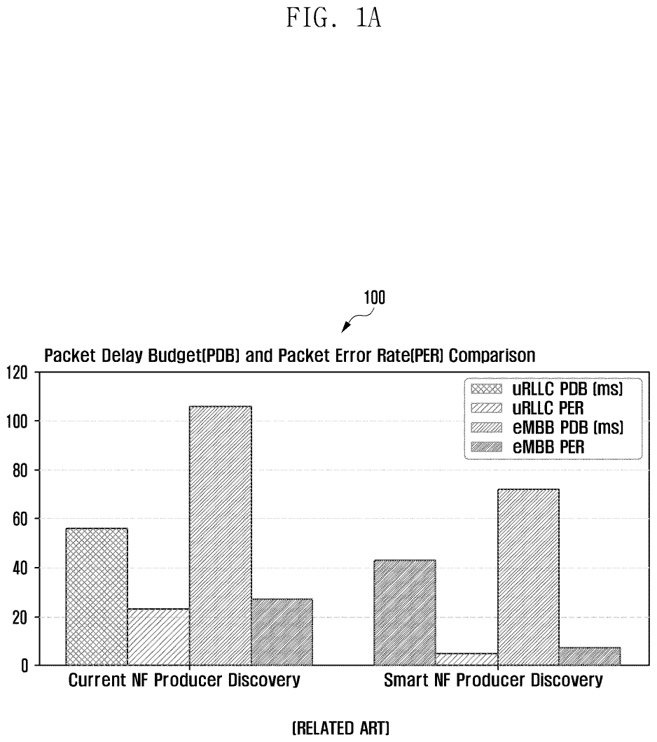

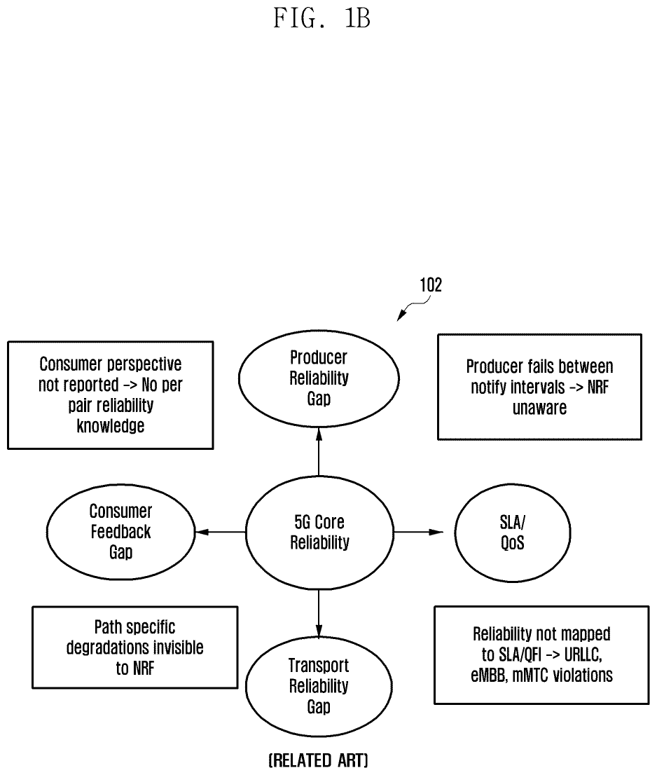

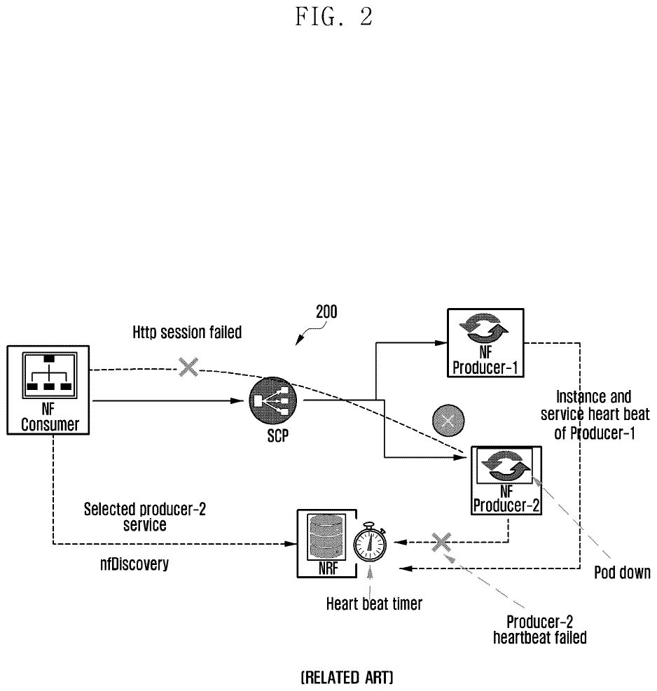

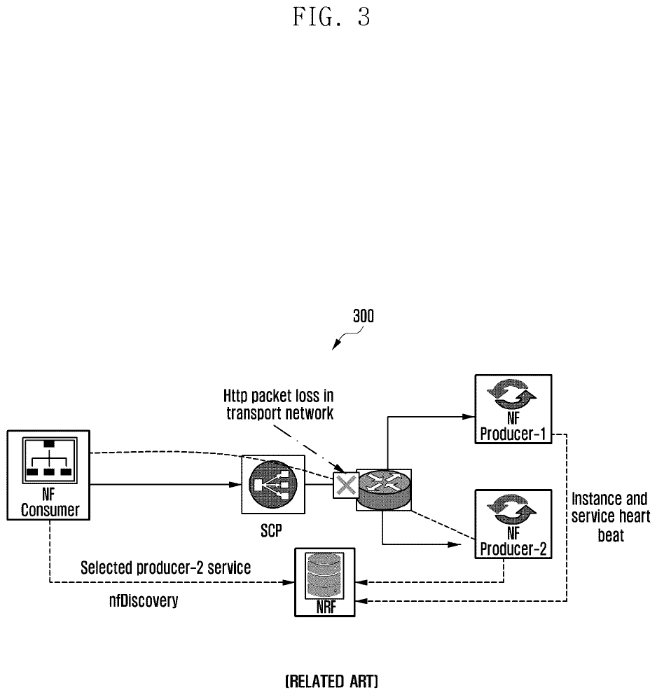

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc. ”, “etcetera”, “e.g.,”, “i.e.,” are merely used herein to mean “serving as an example, instance, or illustration.” Any embodiment or implementation of the disclosure matter described herein using the words/phrases “exemplary”, “example”, “illustration”, “in an instance”, “and the like”, “and so on”, “etc. ”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the operations required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/operations is for the purposes of this description and should not be construed as sequential ordering/placement/occurrence unless specified otherwise.

Embodiments herein disclose methods and systems for optimizing communication reliability in the wireless communication network. The network repository entity receives a communication performance message from a network consumer entity, where the communication performance message is related to a network producer entity. The network repository entity may determine a reliability score for the network producer entity. The network repository entity may select the network producer entity for the network consumer entity based on a local reliability table, wherein the local reliability table comprises the network producer entity with a highest global reliability score. Further, the network repository entity may determine whether the selected network producer entity is compatible with the network consumer entity based on a global reliability table, wherein the global reliability score is determined by aggregating the local reliability score. The network repository entity can update a final selection of the network producer entity with the network consumer entity, for communicating with the network consumer entity, based on a combination of the global reliability table and the local reliability table. The reliability score is received from a Network Data Analytics Function (NWDAF) (or NWDAF entity) for the network producer entity. The reliability score is determined for the network producer entity based on at least one of: the received communication performance message and the historical communication data.

The network repository entity may determine that the local reliability table indicates a suboptimal reliability for the selected network producer entity, wherein an Artificial Intelligence (AI) module generates the suboptimal reliability for checking the local reliability table to the selected network producer entity. The network repository entity may discard the selected network producer entity to continue selecting another network producer entity with a next highest reliability score. The network repository entity selects the network producer entity in an iterative process. The communication performance message comprises at least one of: a network producer profile information and a computed packet loss percentage between the network consumer entity and the network producer entity.

The network consumer entity may compute the packet loss percentage based on a number of retransmitted packets during communication between the network consumer entity and the network producer entity. The consumer entity may transmit the computed packet loss percentage to the network repository entity through a notification, wherein the notification comprises a network producer profile information and the calculated packet loss percentage between the selected network consumer entity and the network producer entity. Further, an Artificial Intelligence (AI) module is configured to compute the reliability score for the network producer entity based on the historical communication data, wherein the AI module generates the reliability score comprising the global reliability score and the local reliability score.

The term “central management entity”, “network repository function”, “NRF” can be referred as “network repository entity”, and can be interchangeably used without altering the meaning.

The term “network producer entity” can be referred as “network function producer”, and can be interchangeably used without altering the meaning.

The term “network consumer entity” can be referred as “network function consumer”, and can be interchangeably used without altering the meaning.

The term “NF”, “network function” can be referred as “network”, and can be interchangeably used without altering the meaning.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

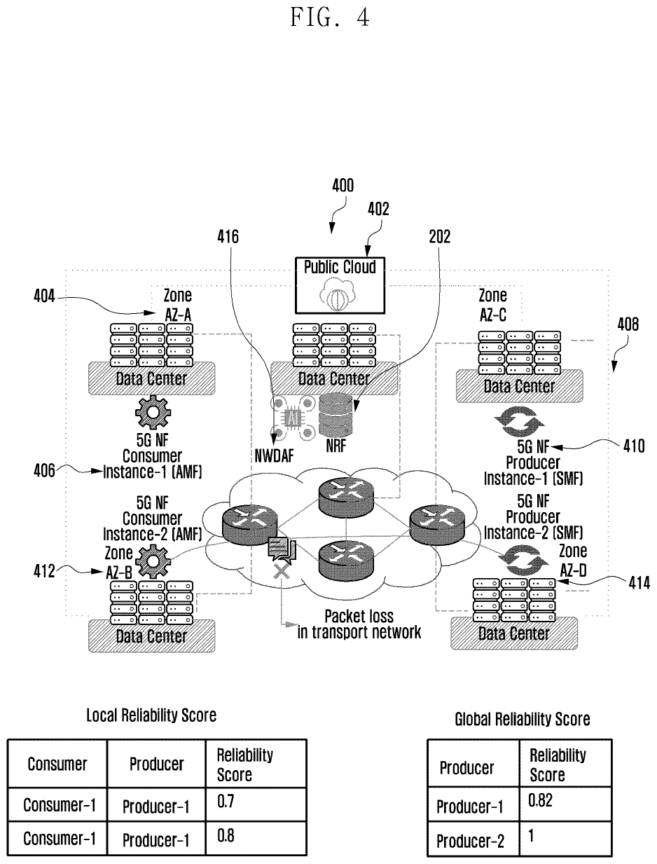

FIG. 4 is an example architecture diagram illustrating the service aware network producer discovery in the 5GC according to an embodiment of the disclosure.

Referring to FIG. 4, in a diagram 400, the multi-zone fifth-generation (5G) core network architecture designed with multiple availability zones such as (AZ-A, AZ-B, AZ-C, AZ-D), each zone comprising data centers that host different 5G Network Functions (NFs). The Access and Mobility Management Function (AMF) instances 406 act as consumers, deployed in AZ-A 404 and AZ-B 412, while the Session Management Function (SMF) instances 410 act as producers, deployed in AZ-C 408 and AZ-D 414. The NFs rely on the Network Repository Function (NRF) or network repository entity 202, located centrally, for service registration and discovery, enabling dynamic communication across zones. A public cloud 402 is integrated at the top, emphasizing scalability and hybrid deployment capability, wherein the transport network, represented as interconnected routers, ensures inter-zone communication, with the vulnerabilities such as packet loss, which can disrupt network interactions.

As illustrated in FIG. 4, the central management entity (i.e., network repository entity 202) in the 5G service-based network for optimizing communication reliability in the wireless communication network between consumers and producers using AI-based reliability evaluation. Firstly, the network repository entity 202 collects communication performance data from the network consumer entity 222, which may include, but not limited to a packet loss, a response time, error rates, and the quality of interactions with different producer instances. The communication performance data can be analyzed by the AI module present in the NWDAF 416 to generate dynamic reliability scores to compute historical trends, recent failures, and predictive stability. The network repository entity 202 maintains continuous updated record of the reliability scores, both at the producer level and for specific consumer-producer pairings. When the consumer requires interaction with the producer, the network repository entity 202 selects the instance based on the evaluated reliability scores, ensuring that requests are routed to the most dependable producer.

Another embodiment as disclosed herein, the network repository entity 202 receives communication performance information from the network consumer entity 222, comprising packet loss percentage and the producer's profile. The AI module in the NWDAF 416 is configured to compute the reliability score for each producer instance using both the reported packet loss and historical performance data. The reliability scores can be stored in two separate tables, such as, a global reliability table, capturing the overall reliability of each producer across all consumers, and a local reliability table, capturing the reliability specific to a given consumer-producer pairing. When the network discovery request is made, the network repository entity 202 selects the producer with the highest global reliability score. The network repository entity 202 checks the local reliability table to ensure the selected producer is compatible with the specific consumer. The network repository entity 202 on identifying if the local entry suggests suboptimal performance, the network repository entity 202 discards the selected producer and evaluates the next-best producer. The iterative process continues until an optimal pairing is found. By combining the global and local reliability metrics, the network repository entity 202 ensures that producer selection is not only based on general performance but also tailored to individual consumer experiences, thereby enhancing end-to-end reliability, reducing communication failures, and improving service quality in the 5G network.

Another embodiment as disclosed herein, the network repository entity 202 can be used to compute the reliability of the producer and determine eligibility as a candidate for a service discovery request. Therefore, the proposed disclosure utilizes a reliability score computing AI module in conjunction with the consumer feedback. The approach introduces consumer-side feedback to the network function entity 202, in addition to traditional producer notifications, thereby enabling bidirectional reliability assessment. It involves the computation of both global reliability scores for producers and local reliability scores for specific consumer-producer pairs within the Network Data Analytics Function (NWDAF) 416. Artificial Intelligence (AI) and Machine Learning (ML) models are employed to dynamically predict reliability based on multiple features rather than static counters. The framework is integrated with the NWDAF 416 for model training, inference, and closed-loop analytics, while ensuring that the NRF (network function entity 202) remains lightweight. Furthermore, services are grouped into families with common Key Performance Indicator (KPI) requirements using a clustering algorithm to simplify threshold tuning. The design is future-proof, extending beyond 5G networks to Next Generation Network (NGN) cores and other distributed architectures.

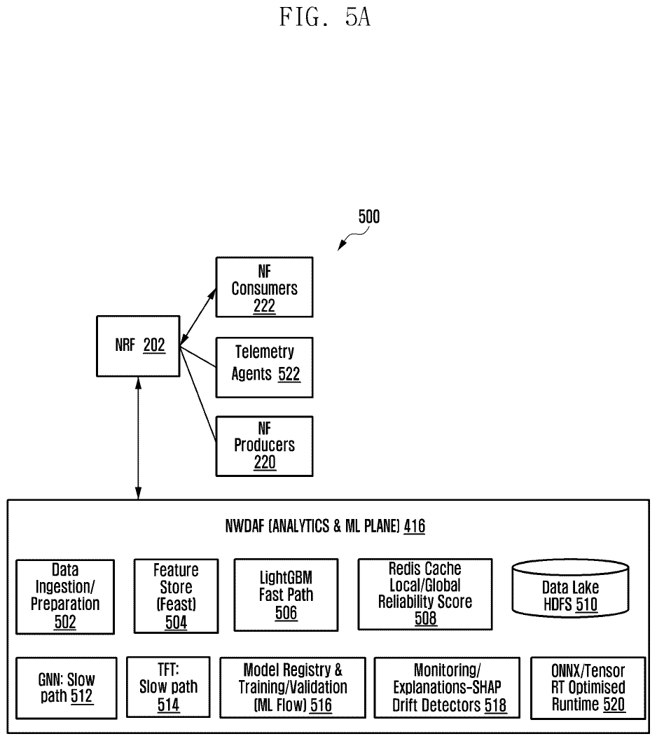

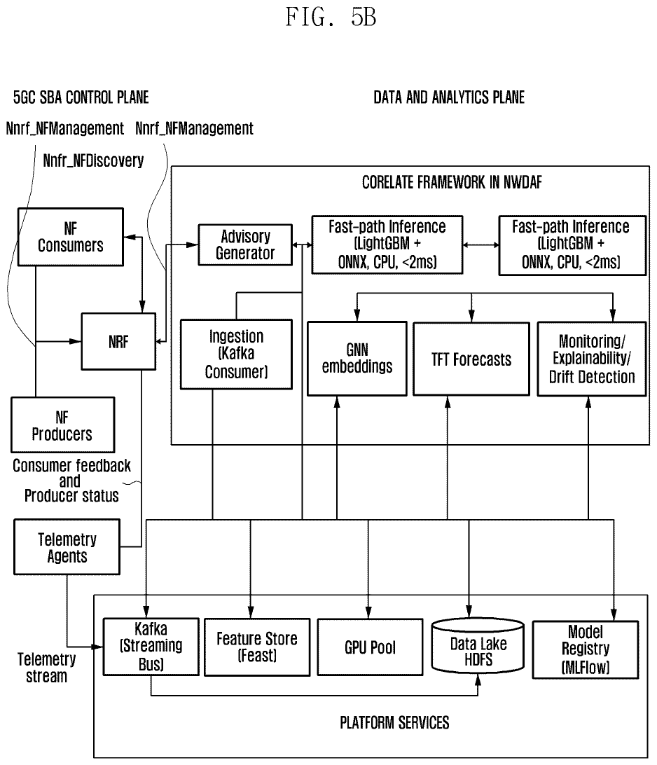

FIG. 5A is an example architecture diagram illustrating the service aware network producer discovery architecture using the NWDAF 416 in the 5GC according to an embodiment of the disclosure. In the 3GPP standard, the network consumer entity 222 performs the discovery request to the Network Repository Function (NRF) (i.e., network repository entity 202). The NRF responds with a list of network producer instances (addresses and metadata) discovered via the NF repository. Producers periodically notify the NRF about the status and metadata.

Referring to FIG. 5A, in 502, discloses integrating consumer feedback. NF consumers can also send status reports (e.g., producer unresponsive, packet loss observed) using the notification callback URI (nfProducerStatusNotificationUri) in the NRF. The mechanism is realized through a lightweight operator extension of the Nnrf_NFManagement update service. The NRF feeds both producer self-reports and consumer observations to the Network Data Analytics Function (NWDAF) via NWDAF's event ingestion interface, using the Nnwdaf_AnalyticsInfo services, for computing reliability scores and ranking priorities before returning producer candidates to the consumer. The NWDAF responds with a ranked list of NF producers satisfying the service class SLA.

Also, a telemetry agent 522 (such as UPF event exposure, SMF logs, application-level probes, and consumer reports) stream events via Kafka to NWDAF's ingestion layer. The ingestion layer validates, deduplicates, and enriches events, writing time-versioned features to a Feature Store (Feast) 504 and raw events to a Data Lake (HDFS) 510. The NWDAF 416 processing pipeline is divided into a fast path 506 (LightGBM inference, Redis cache 508, ONNX runtime optimizations) and a slow path (Graph Neural Network (GNN) embeddings 512, Temporal Fusion Transformers (TFT) forecasts 514, GPU-based training). Model artifacts and metadata are versioned in a Model Registry (MLflow) 516. Therefore, the modular architecture preserves low-latency service discovery while enabling computationally intensive analytics off the critical path.

Embodiment as disclosed herein, for dataset preparation, wherein the message-level features include NF service response codes, retry counters, and per-message latency distributions. Network-level features capture round-trip time (RTT) statistics (p50, p95), packet loss ratios, and retransmission counts. Contextual features encode parameters such as the QoS Flow Identifier (QFI), NF type, slice identifier, and regional placement, using categorical embeddings for efficient model consumption. Historical producer features aggregate producer-level KPIs such as uptime fraction, mean latency over long observation windows, and success variance. All features are time-stamped, windowed at multiple granularities (5 seconds, 30 seconds, and 5 minutes), and materialized in the Feature Store (Feast) to eliminate training-serving skew and ensure consistent feature definitions.

Further, for feature engineering process constructs per-consumer—producer feature vectors incorporating service class, transport KPIs, embeddings, and forecasts. Clustering is applied using the K-means algorithm based on QFI and service class to compute reliability thresholds for each cluster.

In model families, wherein the framework utilizes multiple model families: LightGBM for fast-path classification and regression supporting real-time NRF scoring; Graph Neural Networks (GraphSAGE) for generating producer embeddings that capture topological and functional relationships; and Temporal Fusion Transformers (TFT) for forecasting reliability trends.

GPU-based offline training (using NVIDIA V100, approximately 3-4 hours) optimizes three objectives: (i) binary classification for SLA success or failure, (ii) regression for predicting reliability scores between 0 and 1, and (iii) quantile forecasting for detecting potential producer degradation. The LightGBM model minimizes weighted cross-entropy loss to estimate the probability of SLA success, while the GNN leverages both node features and graph structure to infer producer reliability.

During inference, the fast-path LightGBM model executes on NRF CPUs with sub-2 ms latency per query, while the slow-path GNN and TFT models perform re-computation on GPUs and feed updated insights to the NRF via NWDAF.

In an example, evaluation and adaptation are guided by metrics such as latency, reliability (targeting “five-nines” for URLLC and “two-nines” for eMBB), SLA violation rate, AUC, and Precision@K. Threshold enforced are enforced per service class, including URLLC, eMBB, and mMTC, ensuring optimized and SLA-compliant service discovery decisions.

Referring to FIG. 5B, the 3GPP Service-Based Architecture (SBA) control plane, where Network Function (NF) Producers register and update their status with the Network Repository Function (NRF) over the Nnrf_NFManagement interface, and NF Consumers obtain producer endpoints via Nnrf_ServiceDiscovery are illustrated. All existing interfaces are preserved, ensuring that no non-standard logic is introduced within either the NRF or the NFs. The only augmentation introduced is that NF Consumers emit consumer feedback events—such as producer unresponsiveness or observed packet loss—to the NRF via Nnrf_NFManagement. Additionally, telemetry agents (deployed as daemonsets or sidecars) attached to the NFs export control-plane traces and Key Performance Indicator (KPI) counters. The right plane represents the Data and Analytics Plane, where the Intelligent Framework operates entirely within the Network Data Analytics Function (NWDAF). The NWDAF ingests events from the streaming bus (Kafka) and maintains two complementary processing paths.

The fast path executes a lightweight LightGBM model (served using the ONNX runtime 520) and consults an internal Redis L1 cache to produce per-request reliability estimates and ranked producer candidates within sub-millisecond to millisecond latency.

The slow path performs periodic learning and context building. A Graph Neural Network (GNN) generates producer embeddings that capture topological and behavioral relationships, while a Temporal Fusion Transformer (TFT) forecast short-term reliability trends. A monitoring module further supports model calibration, explainability, and drift detection 518. When the NRF receives a service discovery request, it queries the NWDAF with the requested service metadata via Nnwdaf_AnalyticsInfo to obtain the top-k candidate producers (where k is tunable by the operator) that satisfy the required Quality Flow Identifier (QFI). Outputs from the cache, slow-path models, and fresh signals from the ingestion layer are reconciled by an advisory generator, which issues a versioned and opaque reliability advisory to the NRF.

Platform services surrounding the NWDAF ensure scalability, reproducibility, and compliance with the 3GPP SBA. Kafka carries telemetry and feedback data, while a Feature Store (Feast) serves consistent online features to the fast path and maintains parity with training pipelines. A Data Lake (HDFS) retains raw and historical data for offline analysis and model retraining. A Model Registry (MLflow) versions models and metadata, and a GPU pool accelerates slow-path training jobs. The separation ensures that inference remains on the real-time path, while heavy analytics are handled off the hot path, preserving both low latency and high scalability.

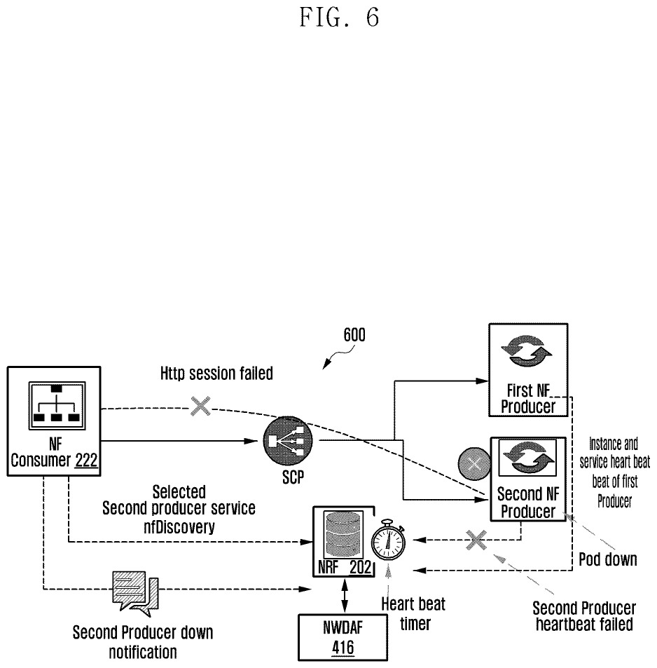

FIG. 6 is an example diagram illustrating the service aware network producer discovery in the 5GC, wherein the producer outage with down, heartbeat timeout, with URLLC focus according to an embodiment of the disclosure.

Referring to FIG. 6, the network consumer entity 222 initiates the discovery of network by sending the request to the network repository entity 202. The network repository entity 202 responds with available producer profiles such as the first producer, and the second producer. The network consumer entity 222 attempts to connect with the second producer, which is in down state. The network repository entity 202 changes the state of the second producer after waiting for the heartbeat timeout. Meanwhile, the network consumer entity 222 establishes a connection to the second producer but receives a connection failure response. Hence, the network consumer entity 222 sends service degraded notification to the network repository entity 202.

When the network consumer entity 222 detects service failure, sends a producer down notification to the Network Repository Function (NRF). The NRF then forwards the consumer report along with producer metadata to the Network Data Analytics Function (NWDAF). Using the received information, the AI Agent identifies that the specific NF producer has violated the Service Level Agreement (SLA) during that period for the corresponding service class, based on the QoS Flow Identifier (QFI) context in the NF consumer. The AI Agent updates the local reliability score accordingly where a classification output of 0 indicates an SLA violation, and regression metrics are computed on KPIs such as packet loss and success rate. For subsequent discovery requests, the updated reliability information assists the lookup process, ensuring that only candidate producers meeting the SLA requirements of the URLLC service class are returned.

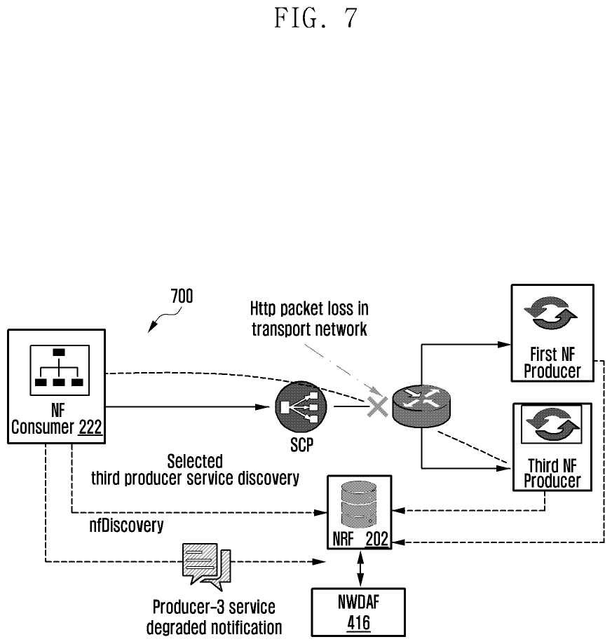

FIG. 7 is an example diagram illustrating the service aware network producer discovery in the 5GC, wherein the consumer-producer specific transport degradation with eMBB focus according to an embodiment of the disclosure.

Referring to FIG. 7, in a diagram 700, the network consumer entity 222 initiates the network discovery process by sending a request to the network repository entity 202. The network repository entity 202 responds by providing the producer profile to the consumer. However, when the consumer attempts to select the second producer for communication, it detects that the second producer is currently in a down state. The NRF (i.e., network repository entity 202) updates the state of second producer only after the heartbeat timeout elapses. Meanwhile, the consumer tries to establish a connection with the second producer but receives a connection failure response. Upon detecting this failure, the consumer sends a producer down notification to the NRF (i.e., network repository entity 202). The NRF (i.e., network repository entity 202) forwards the consumer report along with producer metadata to the Network Data Analytics Function (NWDAF) 416. Based on the input, the AI Agent determines that the network producer entity 212 has violated the Service Level Agreement (SLA) for that period and service class, using the QoS Flow Identifier (QFI) context from the NF consumer. The local reliability score is updated where a classification value of 0 indicates an SLA violation, and regression metrics are computed based on KPIs such as packet loss and success rate. For subsequent discovery requests, the updated information helps the lookup process return candidate producers that meet the SLA requirements of the URLLC service class.

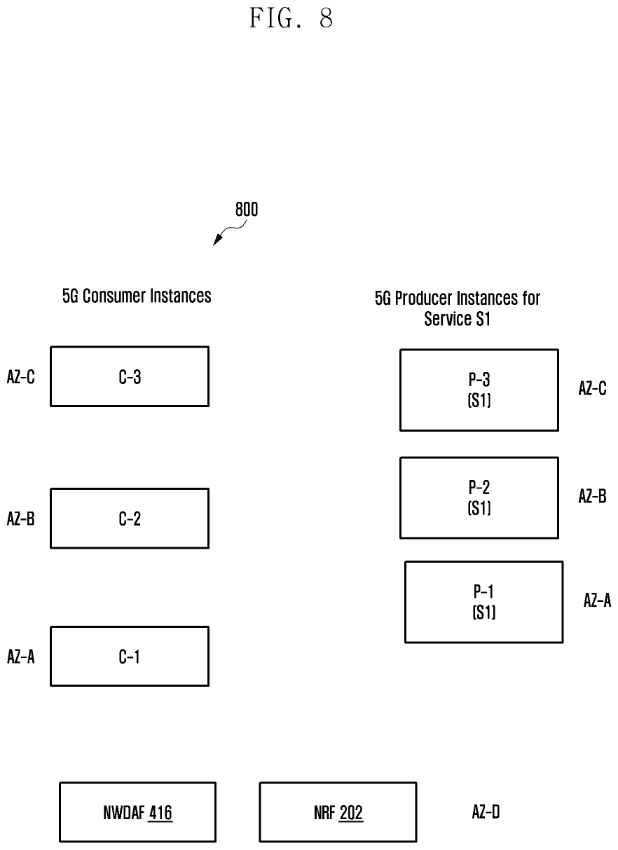

FIG. 8 is an example diagram illustrating a reliability computation using an Artificial Intelligence (AI) module in an Ultra reliable low latency communication (URLLC) according to an embodiment of the disclosure.

Referring to FIG. 8, the diagram 800 shows interactions between the 5G consumer instances and the 5G producer instances for a given service (S1) across different public cloud Availability Zones (AZs). For an instance, three consumer instances are shown such as C-1 in AZ-A, C-2 in AZ-B, and C-3 in AZ-C. Two producer instances for service S1 are depicted as P-1 in AZ-A and P-2 in AZ-B. The network repository entity 202 located in AZ-D, acting as the central entity that maintains network function profiles and supports the network discovery and registration. Each availability zone represents an isolated public cloud zone (such as AWS, Azure, or GCP) with distinct subnets, IP ranges, and configurations. FIG. 8 illustrated the deployment scenario in 5G core cloud-native. The AZ public cloud availability zone, wherein the public cloud environment like AWS, Azure, or GCP, each subnet is typically confined to a single Availability Zone (AZ), meaning that subnets across different AZs will have distinct IP address ranges and network configurations.

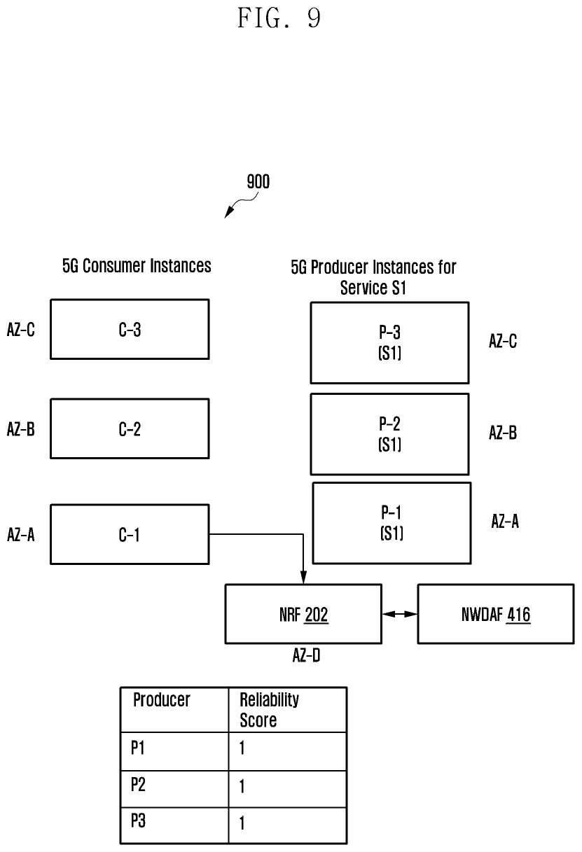

FIG. 9 is an example diagram illustrating the reliability computation using the AI module for performing network discovery to avail services according to an embodiment of the disclosure.

Referring to FIG. 9, in a diagram 900, the network discovery for the service S1 is distributed across multiple Availability Zones (AZs). For an instance, three consumer instances are shown, namely C-1 in AZ-A, C-2 in AZ-B, and C-3 in AZ-C, while two producer instances for Service S1, P-1 in AZ-A and P-2 in AZ-B, are available for communication. The network repository entity 202 deployed in AZ-D to store producer profiles and facilitate discovery requests from the consumers. The NRF 202 acts as a central registry that maintains producer profiles and facilitates discovery requests from consumers. When the consumer attempts to connect to a producer, they may encounter a failed or unresponsive producer. In such cases, the consumer sends a producer down notification to the NRF 202. The NRF aggregates feedback, along with producer self-reports, and forwards the information to the NWDAF (416) for analytics processing. The NWDAF computes reliability scores for each producer based on both self-reports and consumer observations. The scores are classified as “1” indicates a good/healthy producer, 0 indicates a faulty or unhealthy producer, and scores below 0.9 are considered unfit for critical communications such as URLLC (Ultra-Reliable Low Latency Communication).

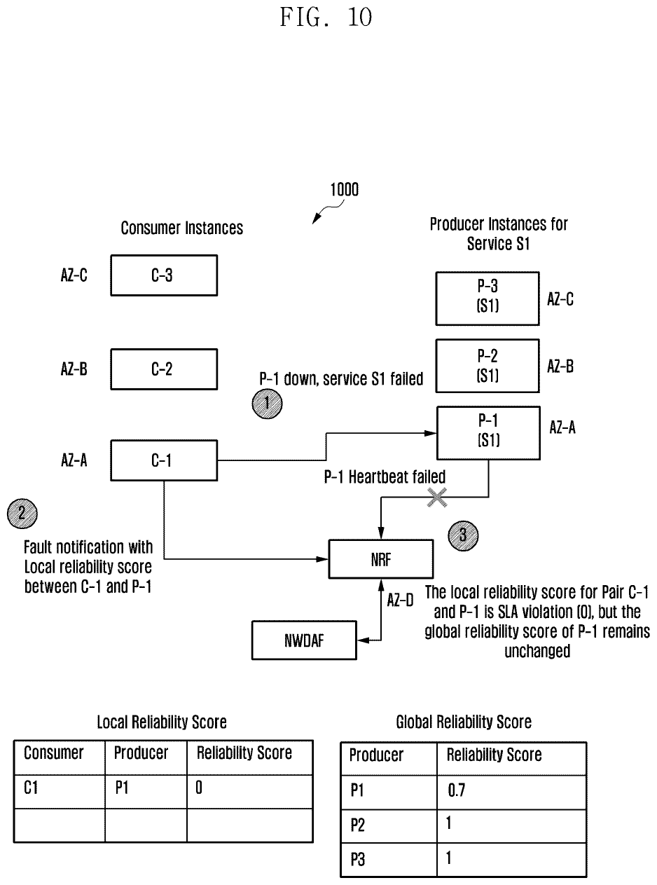

FIG. 10 is an example diagram illustrating the reliability computation using the AI module for calculating the URLLC communication producer outage according to an embodiment of the disclosure.

Referring to FIG. 10, in a diagram 1000, the consumer-driven reliability feedback mechanism in the 5G Service-Based Architecture (SBA) involving Network Function (NF) consumers, NF producers, the Network Repository Function (NRF), and the Network Data Analytics Function (NWDAF). In the illustrated flow, multiple NF consumers (C-1, C-2, C-3) interact with NF producers (P-1, P-2, P-3), each providing a service instance (S1). When a consumer, such as C-2, sends a service request to a selected producer (P-1) and experiences a failure or no response, it generates a Producer Down notification. This notification, along with performance and context information, is sent to the NRF. The NRF aggregates this consumer feedback with producer metadata and forwards it to the NWDAF for analytics. The NWDAF processes the data to update the reliability score of the affected producer, reflecting its current operational health and SLA compliance. During subsequent service discovery requests, the NRF references these updated reliability scores to prioritize and return only healthy and reliable producers, ensuring improved service continuity and adherence to Quality of Service (QoS) requirements.

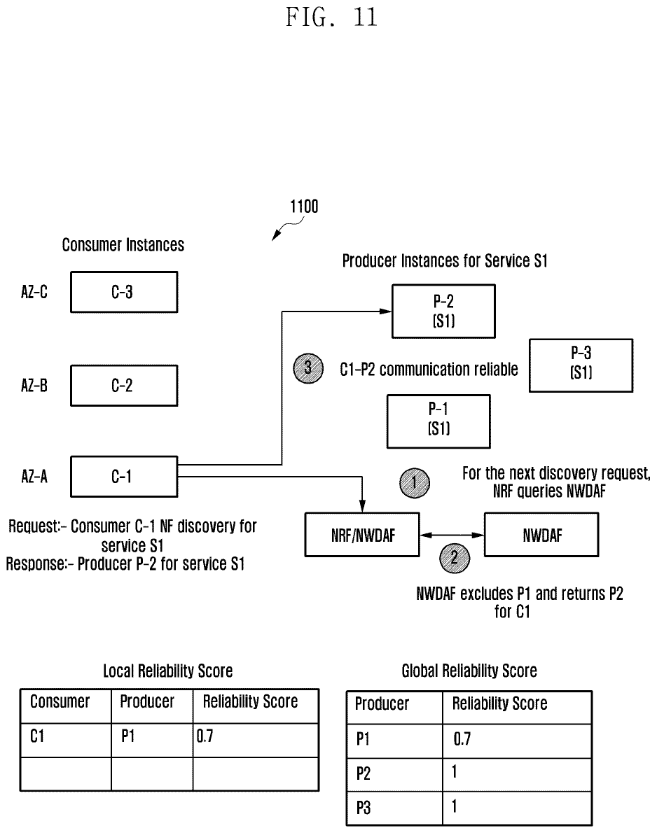

FIG. 11 is an example diagram illustrating the reliability computation using the AI module for requesting subsequent network discovery to avail the service according to an embodiment of the disclosure.

Referring to FIG. 11, in a diagram 1100, three consumer instances (C-1, C-2, and C-3) located in different availability zones (AZ-A, AZ-B, and AZ-C) communicate with producer instances (P-1, P-2, and P-3) that provide service instance S1. During an initial discovery, consumer C-1 establishes communication with producer P-1, but the communication fails, resulting in a local reliability score of 0 for that consumer-producer pair. The Network Repository Function (NRF) forwards this feedback to the Network Data Analytics Function (NWDAF), which updates both the local reliability score (C1−P1=0) and the global reliability score (P1=0.7, P2=1, P3=1) based on aggregated analytics.

In operation 1, for the next discovery request, the NRF queries the NWDAF for updated reliability scores. In operation 2, the NWDAF excludes the unreliable producer (P-1) and returns P-2 as the optimal producer for C-1, since it has a reliability score of 1 and satisfies the SLA requirements. In operation 3, the subsequent communication between C-1 and P-2 is successful and marked as reliable. Referring to FIG. 11, reliability score of 1 denotes a healthy producer, 0 indicates a faulty one, and scores below 0.9 are deemed unsuitable for ultra-reliable low-latency communications (URLLC).

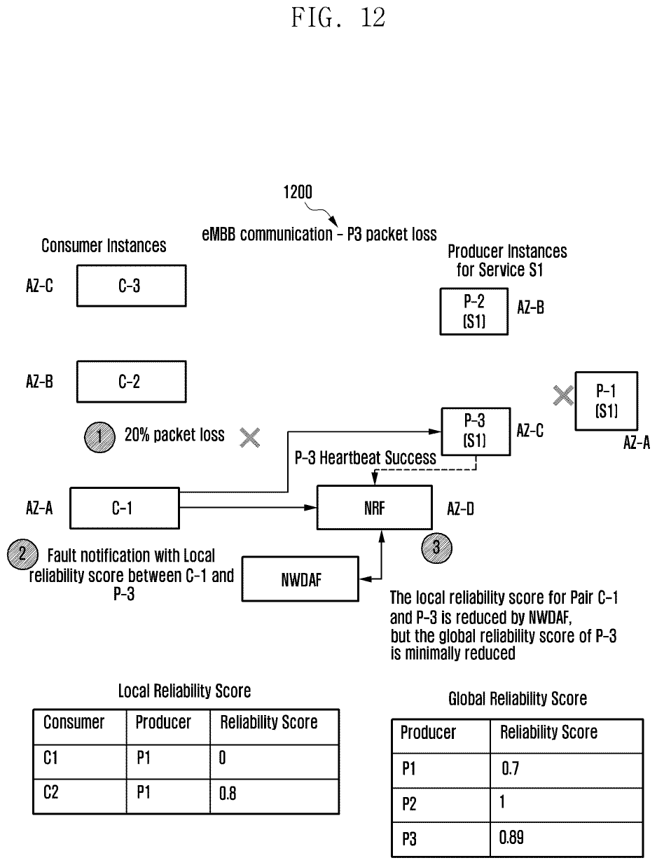

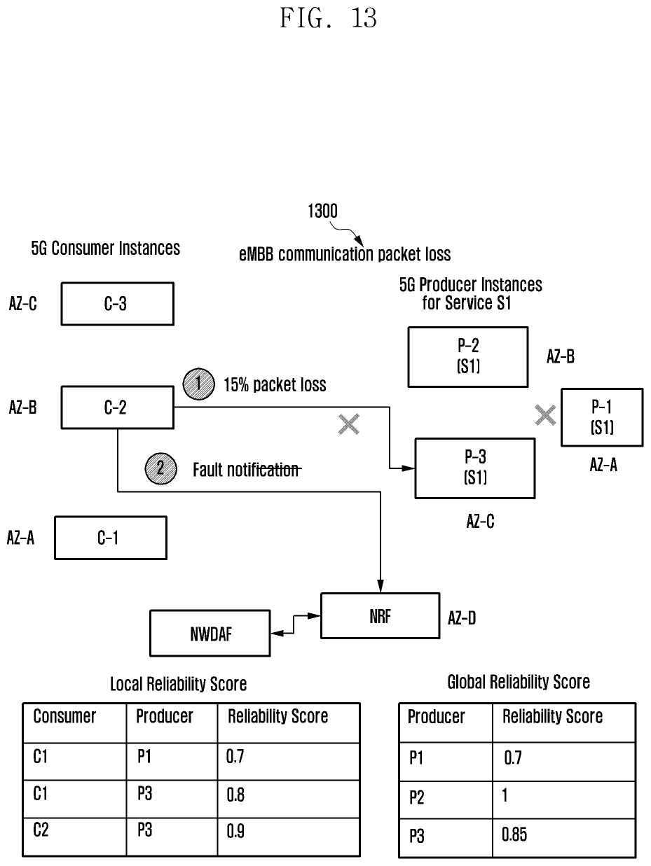

FIGS. 12 and 13 are example diagrams illustrating the reliability computation using the AI module by performing eMBB communication during packet loss according to various embodiments of the disclosure.

Referring to FIG. 12, in a diagram 1200, three consumer instances (C-1, C-2, and C-3) located in availability zones AZ-A, AZ-B, and AZ-C communicate with producer instances (P-1, P-2, and P-3) that provide service instance S1. During communication between C-1 and P-3, the system detects 20% packet loss in an eMBB (enhanced Mobile Broadband) service flow. Although P-3 heartbeat remains successful, indicating that the producer is operational, the performance degradation impacts reliability from the consumer's perspective. The C-1 sends a fault notification to the Network Repository Function (NRF) with a local reliability score update for the C-1−P-3 pair. The NRF forwards this feedback to the Network Data Analytics Function (NWDAF), which analyzes the data and updates both local and global reliability scores. Referring to FIG. 12, the local reliability score for C-1−P-3 is reduced to 0.8, while the global reliability score of P-3 remains slightly reduced at 0.89, indicating overall stability across other consumers. The reliability score scale defines “1” good/healthy, “0” faulty/unhealthy, and less than “0.9” not suitable for critical communication such as Ultra-Reliable Low Latency Communication (URLLC).

Referring to FIG. 13, in a diagram 1300, multiple 5G consumer instances (C-1, C-2, C-3) interact with producer instances (P-1, P-2, P-3) that provide service instance S1 across different availability zones (AZ-A, AZ-B, AZ-C). During Enhanced Mobile Broadband (eMBB) communication between C-2 and P-3, in operation 1, a 15% packet loss is detected, indicating performance degradation despite P-3's operational status. In operation 2, C-2 generates a fault notification containing performance metrics and sends it to the Network Repository Function (NRF). The NRF forwards the feedback to the NWDAF, which employs AI models to compute and update reliability scores. Based on analysis, the local reliability score between C-2 and P-3 is reduced to 0.9, while the global reliability score of P-3 decreases to 0.85 due to multiple supporting evidences from other consumers (e.g., C-1). Meanwhile, P-1 remains at a lower reliability score of 0.7, and P-2 maintains a score of 1, indicating full reliability. The reliability scale defines “1” good/healthy producer, “0” defines faulty or unhealthy producer, scores below “0.9” defines unsuitable for ultra-reliable low-latency communication (URLLC).

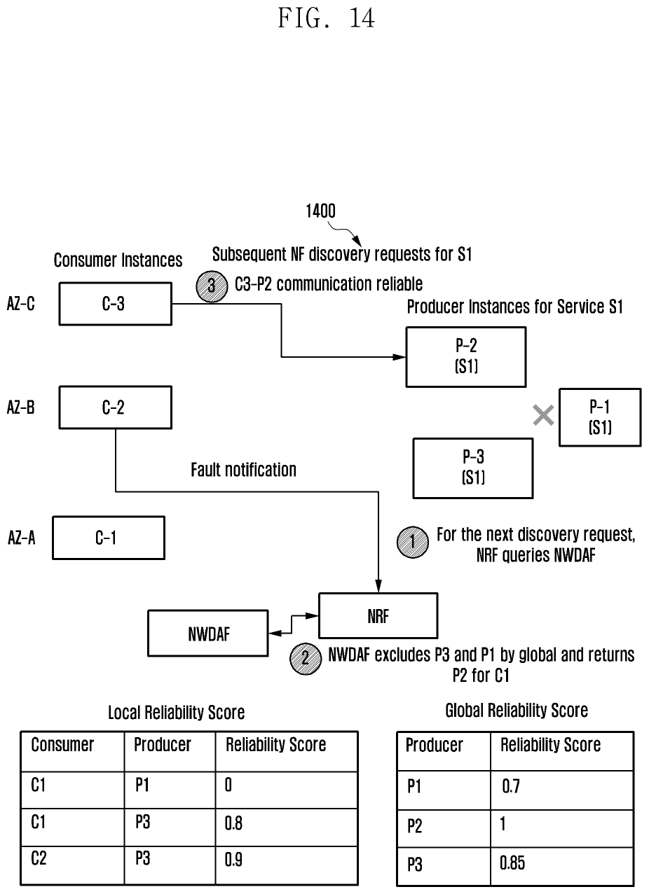

FIG. 14 is an example diagram illustrating the reliability computation using the AI module for subsequent network discovery requests for the first service according to an embodiment of the disclosure.

Referring to FIG. 14, in a diagram 1400, multiple consumer instances (C-1, C-2, and C-3) communicate with producer instances (P-1, P-2, and P-3) providing the same service instance (S1). After previous reliability updates, producers P-1 and P-3 exhibit degraded reliability scores, while P-2 remains fully reliable. In operation 1, when consumer C-1 initiates a new service discovery request, the Network Repository Function (NRF) queries the NWDAF for updated reliability scores. Based on both local reliability scores (specific to consumer-producer pairs) and global reliability scores (aggregated across all consumers). In operation 2, the NWDAF excludes P-1 and P-3 due to their lower scores (P-1=0.7, P-3=0.85) and returns P-2 (score=1) as the optimal candidate for C-1. In operation 3, the communication between C-3 and P-2 is established successfully and marked as reliable, confirming the AI agent's correct selection. FIG. 14 defines reliability score thresholds as “1” defines good/healthy producer, “0” defines faulty or unhealthy producer, below “0.9” defines not suitable for ultra-reliable low-latency communication (URLLC).

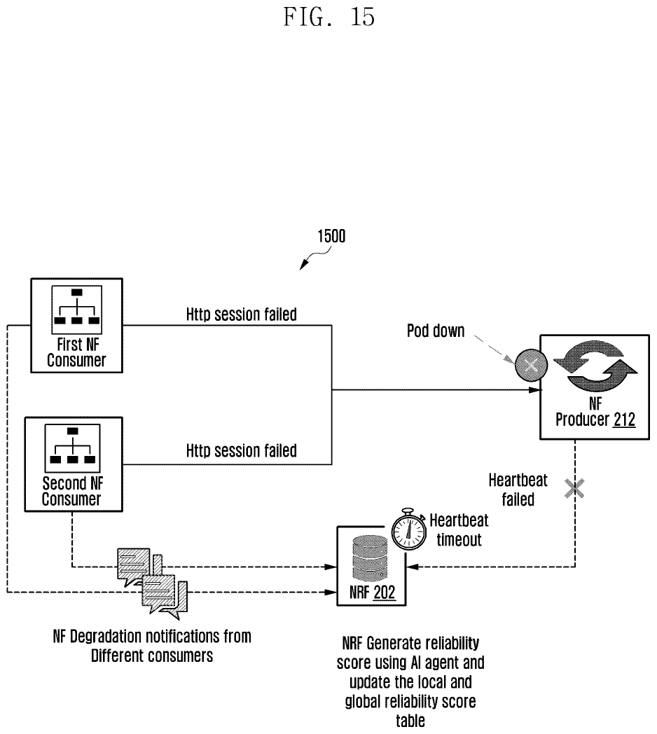

FIG. 15 is an example diagram illustrating the network repository entity collecting the network producer service down notification from the network consumer entity and update reliability score table according to an embodiment of the disclosure.

Referring to FIG. 15, in a diagram 1500, the network consumer entity 222 starts the network discovery by sending the request to the network repository entity 202, which then provides the producer profile to the consumer.

In another instance, when the network consumer entity 222 attempts to select the second producer service for communication, it discovers that the second producer is in a down state. The network repository entity 202 updates the state of the second producer after waiting for the heartbeat timeout, but meanwhile, the network consumer entity establishes a connection with the second producer and receives a connection failure response. Following which, the network consumer entity sends a service degraded notification to the network repository entity 202, including session failure details such as 100% packet loss and the type of communication.

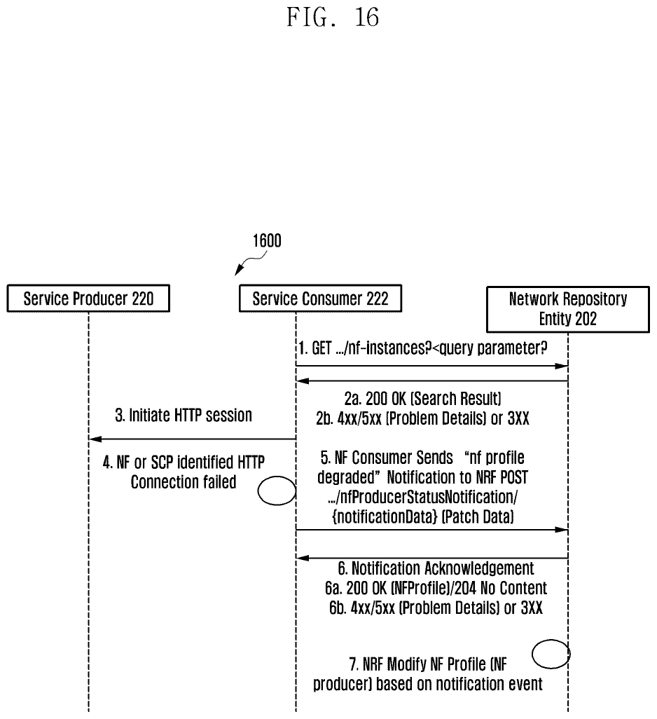

FIG. 16 is an example sequence diagram illustrating the network repository entity collecting the network producer service down notification from the network consumer entity and update reliability score table according to an embodiment of the disclosure.

Referring to FIG. 16, as illustrated in the sequence diagram 1600, in operation 1, the network consumer entity 222 sends a GET request to the network repository entity 202 to discover the network producer entity 220. In operation 2a and 2b, the network repository entity 202 responds with either a 200 OK search result or an error code such as 4xx/5xx or 3xx. In operation 3, the network consumer entity 222 attempts to initiate an HTTP session with the network producer entity 220, but in operation 4, if the network producer entity 220 or SCP detects an HTTP connection failure, the attempt fails. In operation 5, in response, the network consumer entity 222 sends an “nf profile degraded” notification to the network repository entity via a POST request containing patch data about the failure. In operation 6, the network repository entity 202 acknowledges the notification with a response such as 200 OK, 204 No Content, or an error code, and subsequently in operation 7, the network repository entity 202 modifies the network producer profile in records based on the event. Thereby, it ensures that the updated failure state is reflected in the reliability score table, enabling accurate NF discovery and reliable service selection in future consumer requests.

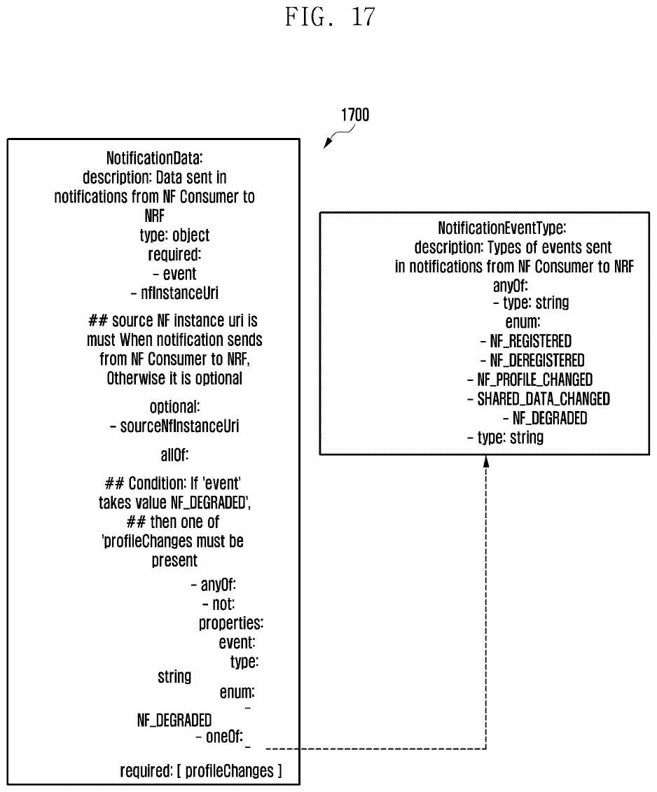

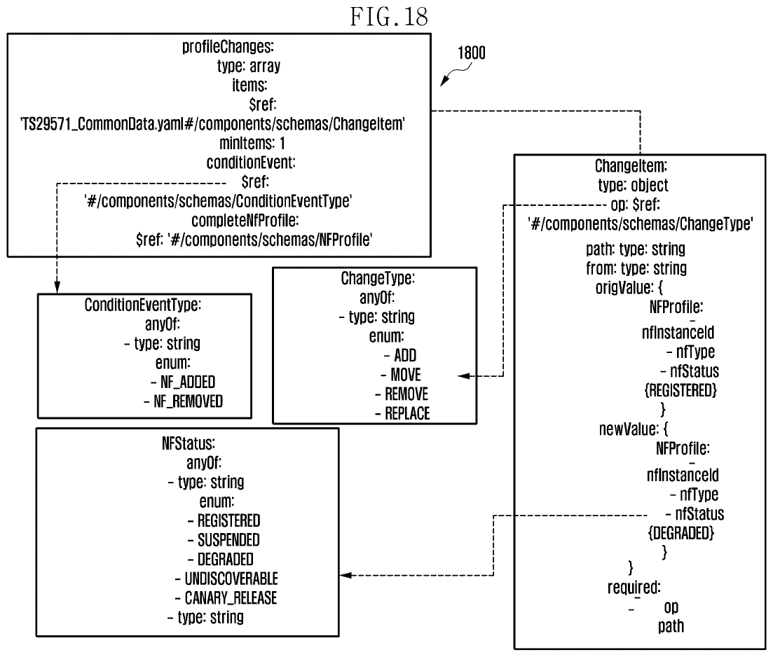

FIGS. 17 and 18 are example diagrams illustrating the network repository entity collecting the network producer service down notification from the network consumer and update reliability score table according to various embodiments of the disclosure.

Referring to FIG. 17, in a diagram 1700, the network repository entity 202 collects failure information from the network consumer entity and updates the reliability score table. When the network consumer detects degraded state (e.g., failed HTTP connection or packet loss) while communicating with an NF Producer, it generates a service degraded notification. The notification includes details such as the degraded status (NF_DEGRADED) and may optionally carry the sourceNfInstanceUri to identify the source NF instance.

Referring to FIG. 18, in a diagram 1800, the network repository entity 202 updates the network producer status based on notifications received from the network consumers when the service failure occurs. Initially, the network producer is registered in the network repository entity with a network profile containing fields such as nfInstanceId, nfType, and nfStatus, where the status is set to “REGISTERED”. When the network consumer detects that the producer service has degraded or become unavailable, it sends service degraded notification to the network repository entity. Upon receiving the notification, the network repository entity updates the network producer profile, modifying the nfStatus field from “REGISTERED” to “DEGRADED”.

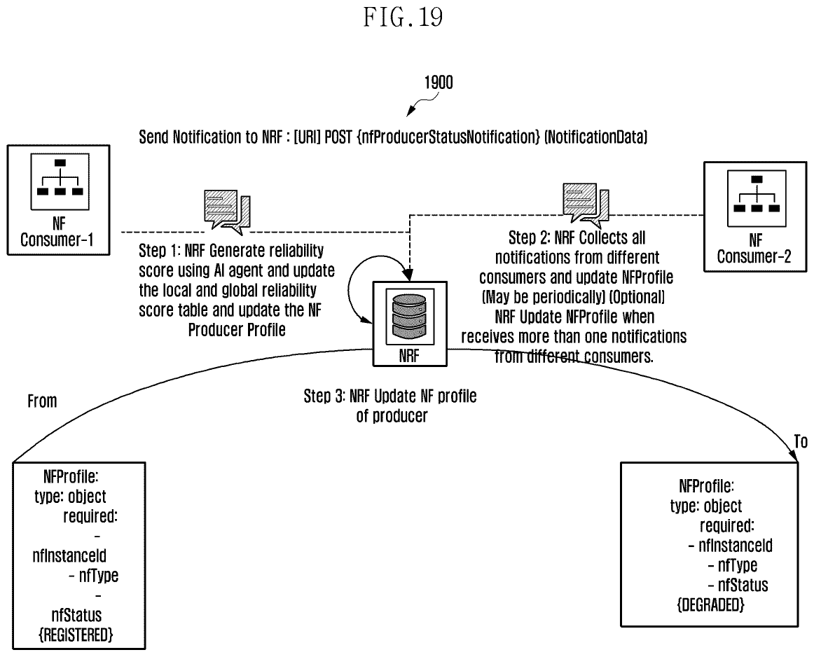

FIG. 19 is an example diagram illustrating the network repository entity collecting the network producer service down notification from the network consumer and update reliability score table according to an embodiment of the disclosure.

Referring to FIG. 19, in a diagram 1900, when the first network consumer or the second network consumer detects the producer service failure, sends notification to the network repository entity 202 using a POST request containing nfProducerStatusNotification and relevant notification data. Referring to FIG. 19, in operation 1, the network repository entity 202 generates reliability score using AI module and update the local and global reliability score table, to update the network producer profile. In operation 2, the network repository entity 202 collects all notifications from different consumers and update the network profile (may be periodically) (optional). The network repository entity 202 may update the network profile when receives more than one notification from different consumers. Finally, in operation 3, the network repository entity 202 update the network profile of the producer.

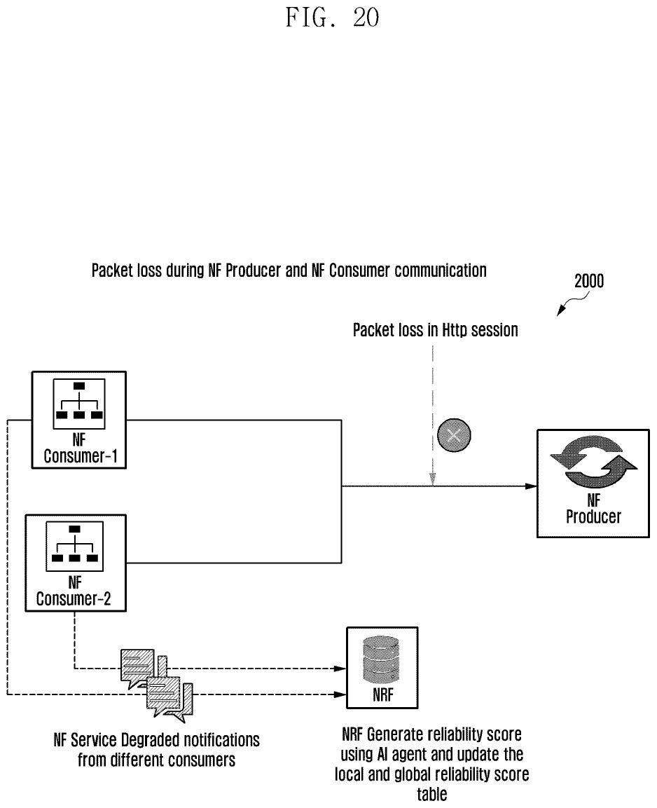

FIGS. 20 to 24 are example diagrams illustrating the network repository entity collecting the network producer entity packet loss notification from the network consumer and update reliability score table according to various embodiments of the disclosure.

Referring to FIG. 20, in a diagram 2000, the first consumer entity and the second consumer entity initiates communication with the producer after receiving profile from the network repository entity 202, but packet loss occurs during the HTTP session. Upon detecting the issue, the consumers send service degraded notifications to the network repository entity 202, including details such as the percentage of packet loss and the type of communication affected. The network repository entity 202, upon receiving the notifications from multiple consumers, processes the information using the AI module to compute updated reliability scores and subsequently updates both the local and global reliability score tables.

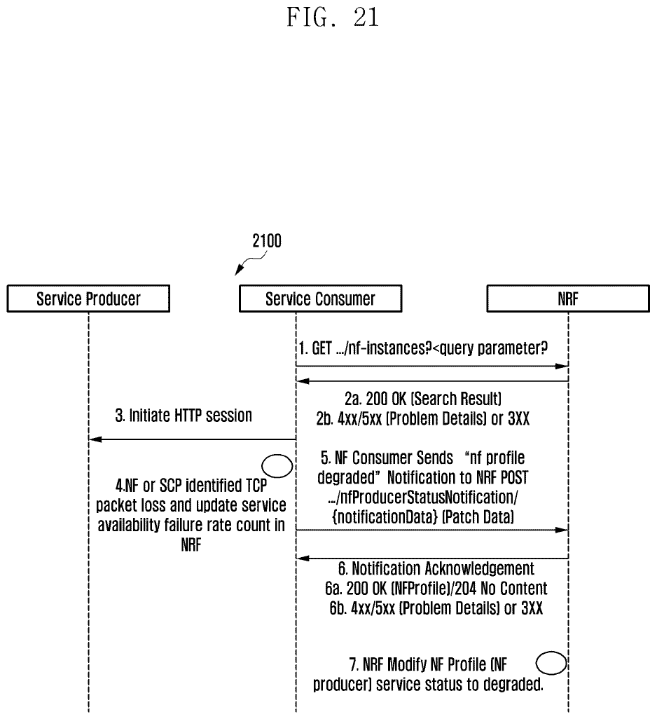

Referring to FIG. 21, in a diagram 2100, in operation 1, when the network consumer entity 222 sends a GET . . . /nf-instances?<query parameter?>request to the network repository entity 202. In operation 2a, the network repository entity 202 responds with either a 200 OK search result, in operation 2b, the network repository entity 202 responds with a 4xx/5xx error with problem details, or a 3xx redirection. In operation 3, the network consumer entity 222 initiates an HTTP session with the network producer entity 220. In operation 4, the network producer or SCP may detect TCP packet loss and update the service availability failure rate count in the network repository entity 202. In operation 5, the network consumer entity 222 sends an “nf service degraded” notification with patch data to the network repository entity 202 using a POST request ( . . . /nfProducerStatusNotification/{NotificationData}). In operation 6, the network repository entity 202 acknowledges notification with a 200 OK (NFProfile), 204 No Content, or a 4xx/5xx/3xx response. In operation 7, the network repository entity 202 updates the network producer profile by changing service status to degraded.

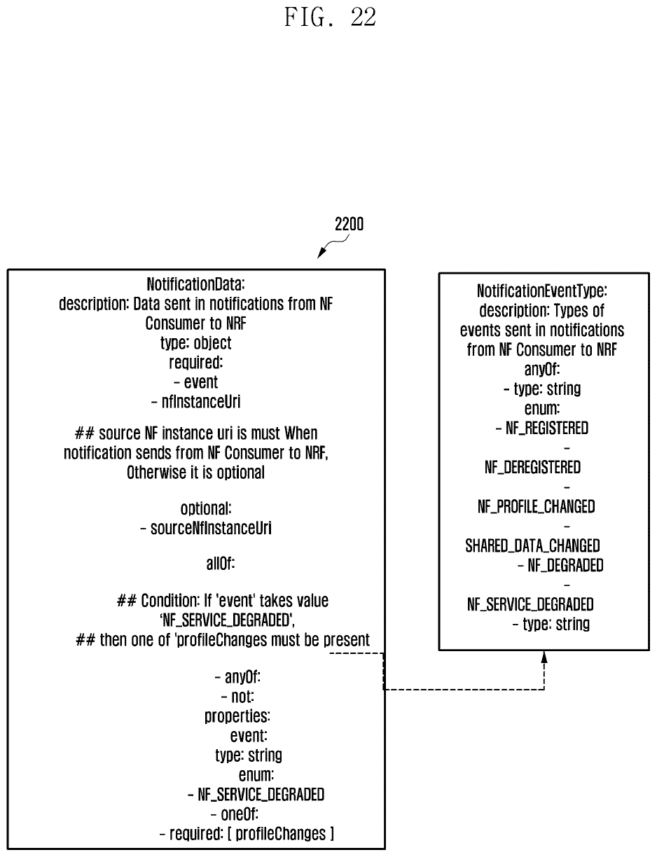

Referring to FIG. 22, in a diagram 2200, the network repository entity 202 collects packet loss notifications from the network consumers entity and updates the reliability score table accordingly according to an embodiment of the disclosure. When the network consumer entity 222 detects packet loss during communication with the network producer entity, sends a service degraded notification containing parameters such as notification type, affected NF instance, and optionally the sourceNfInstanceUri. The notification includes the degraded status NF_SERVICE_DEGRADED. Upon receiving input, the network repository entity 202 processes the notification and updates the network producer profile, modifying the status fields from REGISTERED to NF_DEGRADED and NF_SERVICE_DEGRADED.

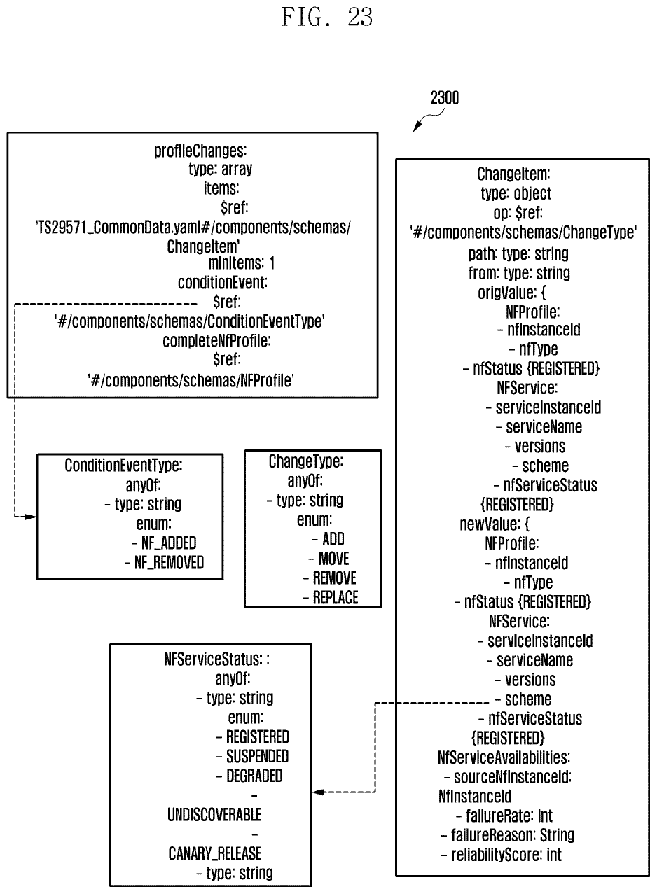

Referring to FIG. 23, in a diagram 2300, the network repository entity 202 collects the producer packet loss notifications from the consumers and updates the reliability score table. Initially, the NF Producer profile (NFProfile) and service details (NFService) are registered with status REGISTERED. When consumers detect packet loss during communication with the producer, the consumer send a degraded notification containing service availability data such as the sourceNfInstanceId, failureRate, failureReason, and reliabilityScore. Based on the received input, the network repository entity updates the producer profile, modifying the service status from REGISTERED to DEGRADED and recording detailed service availability metrics.

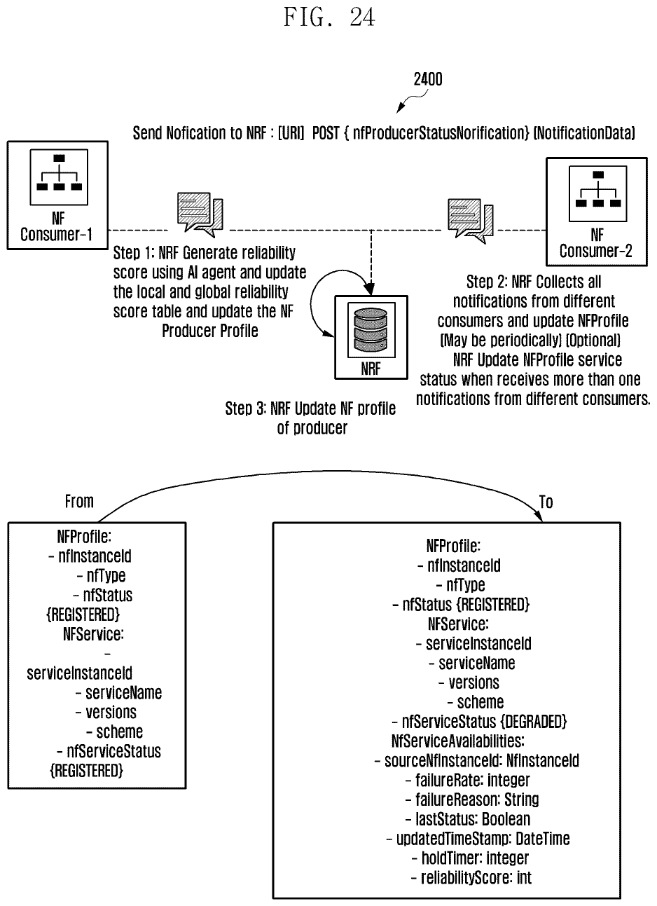

Referring to FIG. 24, in a diagram 2400, the network repository entity 202 collects the producer packet loss notification from the consumer and update reliability score table. In step 1, the network repository entity 202 generates reliability score using AI module and update the local and global reliability score table and further update the producer profile. In step 2, the network repository entity 202 collects all notifications from different consumers and update NFProfile (May be periodically) (Optional) and the network repository entity 202 update profile service status when receives more than one notification from different consumers. In step 3, the network repository entity 202 update profile of the producer.

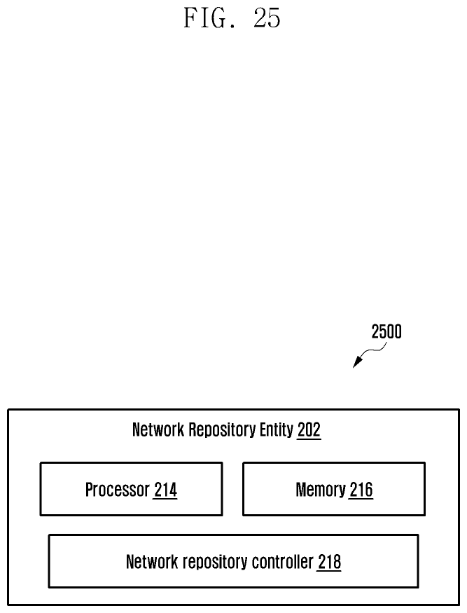

FIG. 25 is an example diagram illustrating hardware components of the network repository entity, for optimizing communication reliability in the wireless communication network according to an embodiment of the disclosure. In an embodiment, the network repository entity 202 comprises a processor 214, memory 216 and a network repository controller 218. The processor 214 is coupled with the memory 216, and the network repository controller 218.

Referring to FIG. 25, in a diagram 2500, the network repository controller 218 is configured to receive communication performance message from the network consumer entity, wherein the communication performance message is related to the network producer entity. The network repository controller 218 determines the reliability score for the network producer entity based on at least one of: the received communication performance message and the historical communication data. The network repository controller 218 selects the network producer entity for the network consumer entity based on the global reliability table, where the global reliability table comprises the network producer entity with the highest global reliability score. The network repository controller 218 determines if the selected network producer entity is compatible with the network consumer entity based on the local reliability table. The network repository controller 218 updates the final selection of the network producer entity with the network consumer entity, for communicating with the network consumer entity, based on the combination of the global reliability table and the local reliability table.

The network repository controller 218 determines that the local reliability table indicates a suboptimal reliability for the selected network producer entity. The network repository controller 218 discards the selected network producer entity to continue selected another network producer entity with a next highest global reliability score. The network repository controller 218 performs iterative process for selecting the network producer entity 220. The network repository controller 218 computes the packet loss percentage based on a number of retransmitted packets during communication between the network consumer entity and the network producer entity. The network repository controller 218 transmits the calculated packet loss percentage to the network repository entity through a notification, wherein the notification comprises a network producer profile information and the calculated packet loss percentage between the selected network consumer entity and the network producer entity. The network repository controller 218 compares the selected network producer entity and the requesting network consumer entity pair against the local reliability table, and on identifying that an entry exists for the producer-consumer entity pair, the selected producer entity is excluded. The network repository controller 218 performs the continuous selection of the next highest global reliability score for another producer entity in the global reliability table.

The handover controller (i.e., network repository controller 218) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 214 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 214 may include multiple cores and is configured to execute the instructions stored in the memory 216.

Further, the processor 214 is configured to execute instructions stored in the memory 216 and to perform various processes. A communicator (not shown) is configured for communicating internally between internal hardware components and with external devices via one or more networks. The memory 216 also stores instructions to be executed by the processor 214. The memory 216 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 216 may, in some examples, be considered a non-transitory storage medium. The term “non-transitory” may indicate that the storage medium is not embodied in a carrier wave or a propagated signal. However, the term “non-transitory” should not be interpreted that the memory 216 is non-movable. In certain examples, a non-transitory storage medium may store data that can, over time, change (e.g., in Random Access Memory (RAM) or cache).

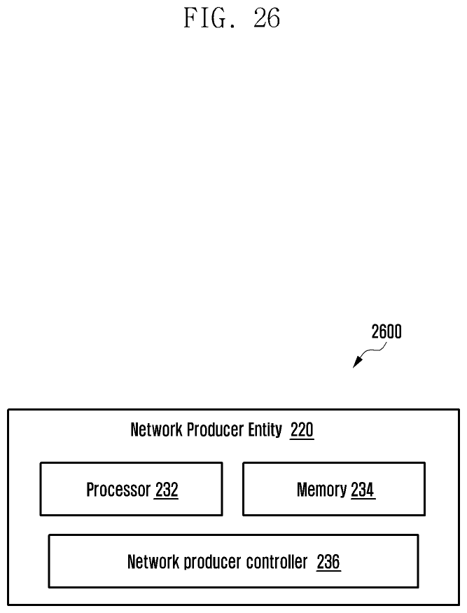

FIG. 26 is an example diagram illustrating hardware components of the network producer entity 220, for optimizing communication reliability in the wireless communication network according to an embodiment of the disclosure. In an embodiment, the network producer entity 220 comprises a processor 232, memory 234, and a network producer controller 236.

Referring to FIG. 26, in a diagram 2600, the network repository entity 202 is configured to manage producer reliability and selection of the producer. The network repository entity 202 receives communication performance messages from consumers, including packet loss, session failures, or service degradation events, and uses the received information along with historical data to compute a reliability score for each network producer. The network repository controller 218 maintains and updates both the global reliability table and the local reliability table for analyzing the reliability between specific consumer-producer pairs. Based on the tables, the network repository controller 218 performs iterative producer selection, ensuring that only producers with the highest reliability and compatibility are paired with consumers. In case of failures, the controller updates the producer's profile status (e.g., from registered to degraded), triggers recalculation of reliability scores, and refines future selections.

The processor 232 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 232 may include multiple cores and is configured to execute the instructions stored in the memory 234.

Further, the processor 232 is configured to execute instructions stored in the memory 234 and to perform various processes. A communicator (not shown) is configured for communicating internally between internal hardware components and with external devices via one or more networks. The memory 234 also stores instructions to be executed by the processor 232. The memory 234 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 234 may, in some examples, be considered a non-transitory storage medium. The term “non-transitory” may indicate that the storage medium is not embodied in a carrier wave or a propagated signal. However, the term “non-transitory” should not be interpreted that the memory 234 is non-movable. In certain examples, a non-transitory storage medium may store data that can, over time, change (e.g., in Random Access Memory (RAM) or cache).

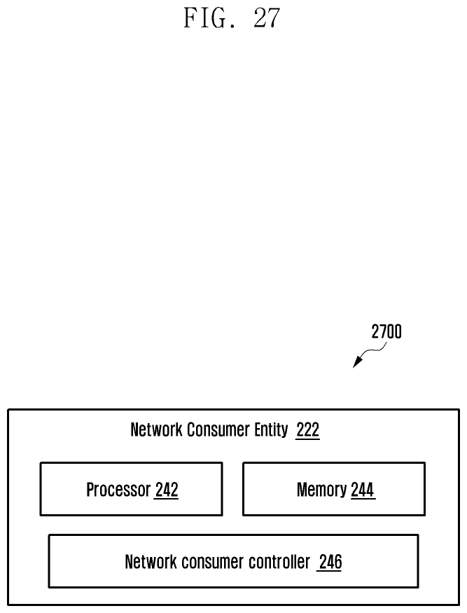

FIG. 27 is an example diagram illustrating hardware components of the network consumer entity, for optimizing communication reliability in the wireless communication network according to an embodiment of the disclosure. In an embodiment, the network consumer entity 222 comprises a processor 242, memory 244, and a network consumer controller 246.

Referring to FIG. 27, in a diagram 2700, the network consumer controller 246 is configured to initiate communication with the network repository entity by sending discovery requests and reporting communication performance information related to the network producer entity. The network consumer controller 246 is configured to monitor producers and compute performance metrics such as packet loss percentage, session failures, and types of communication. The network consumer controller 246 on analyzing degradation and failure, generates and transmits service degraded or service down notifications to the network repository entity, which include producer profile information and calculated reliability. The notifications enable the network repository entity 202 to update the local and global reliability tables, refine producer reliability scores (with the help of the AI/DRL module), and ensure compatibility while selecting producers.

The processor 242 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 242 may include multiple cores and is configured to execute the instructions stored in the memory 244.

Further, the processor 242 is configured to execute instructions stored in the memory 244 and to perform various processes. A communicator (not shown) is configured for communicating internally between internal hardware components and with external devices via one or more networks. The memory 244 also stores instructions to be executed by the processor 242. The memory 244 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 244 may, in some examples, be considered a non-transitory storage medium. The term “non-transitory” may indicate that the storage medium is not embodied in a carrier wave or a propagated signal. However, the term “non-transitory” should not be interpreted that the memory 244 is non-movable. In certain examples, a non-transitory storage medium may store data that can, over time, change (e.g., in Random Access Memory (RAM) or cache).

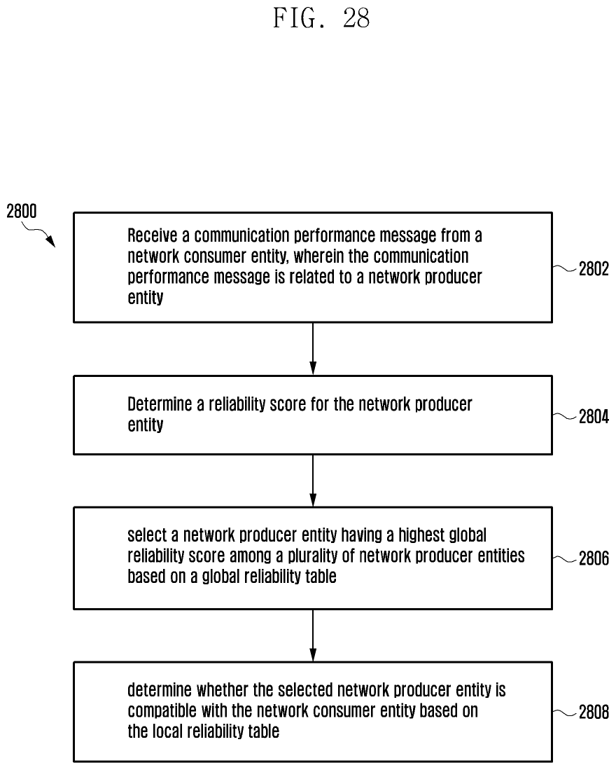

FIG. 28 is an example flow diagram 2800 depicting a method for optimizing communication reliability in the wireless communication network by the network repository entity 202 according to an embodiment of the disclosure.

Referring to FIG. 28, as depicted in operation 2802, the network repository entity 202 may receive a communication performance message from a network consumer entity, wherein the communication performance message is related to a network producer entity. In operation 2804, the network repository entity 202 may determine a reliability score for the network producer entity. the reliability score includes a local reliability score indicating a reliability between the network consumer entity and the network producer entity and a global reliability score indicating reliability of the network producer entity based on aggregated local reliability scores across a plurality of network consumer entities including the network consumer entity. In operation 2806, the network repository entity 202 may select the network producer entity having a highest global reliability score among a plurality of network producer entities based on a global reliability table, wherein the global reliability table comprises a plurality of global reliability scores of the plurality of network producer entities. The network repository entity 202 may select the network producer entity for the network consumer entity based on a local reliability table, wherein the local reliability table comprises the network producer entity with a highest local reliability score. In operation 2808, the network repository entity 202 may determine whether the selected network producer entity is compatible with the network consumer entity based on the local reliability table. The network repository entity 202 may determine whether the selected network producer entity is compatible with the network consumer entity based on a global reliability table.

The various actions, acts, blocks, operations, or the like in the flow charts/diagram 2800 may be performed in the order presented, in a different order or simultaneously. Further, in some embodiments, some of the actions, acts, blocks, operations, or the like may be omitted, added, modified, skipped, or the like without departing from the scope of the disclosure.

The embodiments disclosed herein can be implemented through at least one software program running on at least one hardware device and performing network management functions to control the network elements. The elements include blocks which can be at least one of a hardware device, or a combination of hardware device and software module.

Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an application-specific integrated circuit (ASIC), or a combination of hardware and software means, e.g., an ASIC and an field programmable gate array (FPGA), or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network repository entity for optimizing communication reliability in a wireless network, the method comprising:
receiving, by the network repository entity, a communication performance message from a network consumer entity, wherein the communication performance message is related to a network producer entity;
determining, by the network repository entity, a reliability score for the network producer entity, the reliability score including a local reliability score indicating a reliability between the network consumer entity and the network producer entity and a global reliability score indicating reliability of the network producer entity based on aggregated local reliability scores across a plurality of network consumer entities including the network consumer entity;
selecting, by the network repository entity, a network producer entity having a highest global reliability score among a plurality of network producer entities based on a global reliability table, wherein the global reliability table comprises a plurality of global reliability scores of the plurality of network producer entities;
determining, by the network repository entity, whether the selected network producer entity is compatible with the network consumer entity based on the local reliability table, wherein the local reliability table comprises a plurality of local reliability scores between each of the plurality of network producer entities and the network consumer entity.

2. The method of claim 1, wherein the method further comprises:
based on determining that the selected network producer entity is compatible with the network consumer entity, updating, by the network repository entity, the selection of the network producer entity with the network consumer entity, for communicating with the network consumer entity, based on a combination of the global reliability table and the local reliability table.

3. The method of claim 1, wherein the reliability score is received, from a network data analytics function (NWDAF), for the network producer entity.

4. The method of claim 1, wherein the reliability score for the network producer entity is determined based on at least one of: the received communication performance message or historical communication data.

5. The method of claim 1, wherein the method further comprises:
determining, by the network repository entity, that the local reliability table indicates a suboptimal reliability for the selected network producer entity, wherein an artificial intelligence (AI) module generates the suboptimal reliability for checking the local reliability table to the selected network producer entity; and
discarding, by the network repository entity, the selected network producer entity to continue selecting another network producer entity with a next highest global reliability score.

6. The method of claim 1, wherein the method further comprises selecting, by the network repository entity, the network producer entity in an iterative process.

7. The method of claim 1, wherein the communication performance message comprises at least one of:
a network producer profile information or a computed packet loss percentage between the network consumer entity and the network producer entity.

8. The method of claim 5,
wherein the method further comprises:
computing, by the network consumer entity, a packet loss percentage based on a number of retransmitted packets during communication between the network consumer entity and the network producer entity, and
transmitting, by the network consumer entity, the computed packet loss percentage to the network repository entity through a notification, and
wherein the notification comprises a network producer profile information and the computed packet loss percentage between the selected network consumer entity and the network producer entity.

9. The method of claim 1,
wherein an artificial intelligence (AI) module is configured to compute the reliability score for the network producer entity based on historical communication data, and
wherein the AI module generates the reliability score comprising the global reliability score and the local reliability score.

10. The method of claim 1, wherein the network repository entity comprises:
receiving a network discovery request from the network consumer entity, queries the highest local score;
identifying that the score is available, use the queried score for the network producer entity; and
identifying that the score is not available in the local reliability table, performs comparison with other producers in the global reliability table.

11. The method of claim 1, wherein the method further comprises:
comparing, by the network repository entity, the local reliability scores of the network producer entity that exist for requested network consumer entity in the local reliability table against the global reliability scores of network producer entities that do not exist for the requested network consumer entity in the local reliability table; and
performing, by the network repository entity, the selection of the network producer entity with the highest reliability score based on the comparison.

12. The method of claim 1, wherein the method further comprises:
ensuring, by the network repository entity, that an iterative process of querying the global reliability table and validating against the local reliability table to select appropriate network producer entity for the requesting network consumer entity based on the global reliability table and the local reliability table.

13. The method of claim 12, wherein the method further comprises:
updating, by the network repository entity, the producer selection for the network consumer entity on completion of the iterative process, to facilitate reliability-aware pairing between the network consumer entity and the network producer entity.

14. The method of claim 8, wherein the AI module further comprises:
a light gradient boosted machine (LightGBM) model configured to perform fast-path inference to generate reliability score;
a graph neural network (GNN) configured to learn topological and contextual embeddings of network producer entity; and
a temporal fusion transformer (TFT) configured to capture temporal dependencies and forecast reliability trends based on historical telemetry and feedback data.

15. The method of claim 1,
wherein on detecting a failed communication session with the selected network producer entity, the network consumer entity is configured to transmit a service degraded notification to the network repository entity, and
wherein the service degraded notification comprises at least one of:
an indicating of a session failure,
a packet loss percentage in the failed session, or
a type of communication associated with the failed session.

16. The method of claim 2, wherein on receiving a service down notification from the network consumer entity, the network repository entity is configured to:
update, by the NWDAF, a network producer profile status from a registered to a degraded state;
generating, by the NWDAF, an updated reliability score for an affected network producer entity;
update, by the NWDAF, a local reliability score table and a global reliability score table based on the notification; and
update, by the NWDAF, a network producer profile on receiving multiple service down notifications from various network consumer entity.

17. The method of claim 16, wherein, in case of a failure, the network producer profile status is changed from registered to degraded.

18. The method of claim 17, wherein, when the network producer profile status is changed from registered to degraded, trigger recalculation of local and global reliability scores.

19. A network repository entity, comprising:
memory, comprising one or more storage media, storing instructions;
a network repository controller; and
one or more processors communicatively coupled with the network repository controller and the memory,
wherein the instructions, when executed by the one or more processors individually or collectively, cause the network repository entity to:
receive a communication performance message from a network consumer entity, wherein the communication performance message is related to a network producer entity,
determine a reliability score for the network producer entity, the reliability score including a local reliability score indicating a reliability between the network consumer entity and the network producer entity and a global reliability score indicating reliability of the network producer entity based on aggregated local reliability scores across a plurality of network consumer entities including the network consumer entity,
select a network producer entity having a highest global reliability score among a plurality of network producer entities based on a global reliability table, wherein the global reliability table comprises a plurality of global reliability scores of the plurality of network producer entities,
determine whether the selected network producer entity is compatible with the network consumer entity based on the local reliability table, wherein the local reliability table comprises a plurality of local reliability scores between each of the plurality of network producer entities and the network consumer entity.

20. One or more non-transitory computer-readable storage media storing one or more computer programs including computer-executable instructions that, when executed by one or more processors of a network repository entity individually or collectively, cause the network repository entity to perform operations, the operations comprising:
receiving, by the network repository entity, a communication performance message from a network consumer entity, wherein the communication performance message is related to a network producer entity;
determining, by the network repository entity, a reliability score for the network producer entity, the reliability score including a local reliability score indicating a reliability between the network consumer entity and the network producer entity and a global reliability score indicating reliability of the network producer entity across a plurality of network consumer entities including the network consumer entity;
selecting, by the network repository entity, the reliability score including a local reliability score indicating a reliability between the network consumer entity and the network producer entity and a global reliability score indicating reliability of the network producer entity based on aggregated local reliability scores across a plurality of network consumer entities including the network consumer entity;
determining, by the network repository entity, whether the selected network producer entity is compatible with the network consumer entity based on the local reliability table, wherein the local reliability table comprises a plurality of local reliability scores between each of the plurality of network producer entities and the network consumer entity.
